(19) United States
(12) Patent Application Publication
(10) Pub. No.: US 2016/0104225 A1
(43) Pub. Date: Apr. 14, 2016

(54) ELECTRONIC SHOPPING ASSISTANT AND FOOD LABEL READER

(71) Applicants: Leland Stillman, Portland, ME (US); Steven Hennenfent, Walled Lake, MI (US)

(72) Inventors: Leland Stillman, Portland, ME (US); Steven Hennenfent, Walled Lake, MI (US)

(21) Appl. No.: 14/877,135

(22) Filed: Oct. 7, 2015

Related U.S. Application Data
(60) Provisional application No. 62/062,327, filed on Oct. 10, 2014.

(51) Int. Cl. G06Q 30/06

(52) U.S. Cl. CPC G06Q 30/0623; G06Q 30/0633

(57) ABSTRACT

A method for reviewing a product and providing a recommendation is described. The method includes receiving, at a server, a product identifier and a group identifier from a first device. Product information is determined based on the product identifier. The group identifier is used to determine at least one profile preference which can indicate various dietary goals. The method also includes generating a product report for the product identified by the product identifier based on the product information and the at least one profile preference. The product report includes at least one graphic indication of whether the product meets the at least one profile preference. The product report is sent to the first device from the server. Meal planning, recipes, shopping lists (including coupon keeping), food goal tracking and advertisements are also provided based on the profile preferences. Apparatus and computer readable media are also described.

### STATEMENT REGARDING FEDERALLY SPONSORED RESEARCH OR DEVELOPMENT

N/A

### BACKGROUND

Various embodiments relate to computer assisted shopping therefor, and, more specifically, to methods, devices and systems to provide shopping assistance including the use of a food label reader application.

Shoppers are constantly looking for ways to improve their ability to find bargains and to make wise choices when deciding what to buy. This is especially true when shopping for groceries and selecting meals. Picking the right items to buy is further complicated by various medical concerns and taste preferences of the person and anyone they may be shopping for.

What is needed is a way for consumers to effectively factor in the various interests and help them to select food that meets their needs.

### SUMMARY

The below summary is merely representative and non-limiting.

The above problems are overcome, and other advantages may be realized, by the use of the embodiments.

In a first aspect, an embodiment provides a method for reviewing a product and providing a recommendation. The method includes receiving, at a server, a product identifier (ProductID) and a group identifier (GroupID) from a first device. Product information is determined based on the ProductID, for example, by looking up the ProductID in a database. At least one profile preference is determined based on the GroupID. The method also includes generating a product report for the product identified by the ProductID based on the product information and the at least one profile preference. The product report includes at least one graphic indication of whether the product meets the at least one profile preference. The product report is sent to the first device from the server.

In another aspect, an embodiment provides an apparatus (such as a server, for example) for reviewing a product and providing a recommendation. The apparatus includes one or more processors and one or more memories. The memories storing computer program code. The memories and the computer program code are configured to, with the processors, cause the apparatus to perform actions. The actions include receiving, at the apparatus, a ProductID and a GroupID from a first device. Product information is determined based on the ProductID. At least one profile preference is determined based on the GroupID. The actions also include generating a product report for the product identified by the ProductID based on the product information and the at least one profile preference. The product report includes at least one graphic indication of whether the product meets the at least one profile preference. The product report is sent to the first device from the server.

In a further aspect, an embodiment provides a computer readable medium for reviewing a product and providing a recommendation. The computer readable medium is tangibly encoded with a computer program executable by a processor to perform actions. The actions include receiving a ProductID and a GroupID from a first device. Product information is determined based on the ProductID. At least one profile preference is determined based on the GroupID. The actions also include generating a product report for the product identified by the ProductID based on the product information and the at least one profile preference. The product report includes at least one graphic indication of whether the product meets the at least one profile preference. The product report is sent to the first device.

### BRIEF DESCRIPTION OF THE DRAWINGS

Aspects of the described embodiments are more evident in the following description, when read in conjunction with the attached Figures.

FIG. 1 shows a simplified block diagram of a phone and food package suitable to practice an embodiment.

FIG. 2 shows a block diagram of a computer system suitable to practice an embodiment.

FIG. 3 illustrates a login screen in accordance with an embodiment of a software application.

FIG. 4 illustrates a home screen.

FIG. 5 illustrates a registration screen.

FIG. 6 illustrates an account settings screen.

FIG. 7 illustrates a profile creation screen.

FIG. 8 illustrates a profile review screen.

FIG. 9 illustrates a scan and search screen.

FIG. 10 illustrates a failed search pop-over screen.

FIG. 11 illustrates a screen to assist adding an item manually.

FIG. 12 illustrates a product report screen.

FIG. 13 illustrates a screen to assist adding a scanned item to a shopping list and/or a meal planner.

FIG. 14 illustrates a screen to assist adding an item marked as purchased to a shopping list and/or a meal planner.

FIG. 15 illustrates a pop-over screen to assist creating a new shopping list.

FIG. 16 illustrates a screen to assist adding an item to a meal planner.

FIG. 17 illustrates a screen showing shopping lists.

FIG. 18 illustrates a pop-over screen to confirm deleting a shopping list.

FIG. 19 illustrates another pop-over screen to assist creating a new shopping list.

FIG. 20 illustrates a screen showing an active shopping list.

FIG. 21 illustrates a pop-over screen requesting information when marking an item from a shopping list as not purchased.

FIG. 22 illustrates a pop-over screen requesting information when marking an item from a shopping list as purchased.

FIG. 23 illustrates a pop-over screen providing a warning when closing a shopping list with unmarked items.

FIG. 24 illustrates a screen showing a closed shopping list.

FIG. 25 illustrates a meal planner and journal screen.

FIG. 26 illustrates a pop-over screen requesting information regarding meals selected for a profile.

FIG. 27 illustrates a screen showing pre-planned meal categories.

FIG. 28 illustrates a screen showing sample meals in a pre-planned meal category.

FIG. 29 illustrates a screen showing a sample meal.

FIG. 30 illustrates a screen showing a status report for a selected profile.

FIG. 31 illustrates a meal data screen.

FIG. 32 illustrates a coupon keeper screen.

FIG. 33 shows a signaling diagram of a scan and search operation in accordance with an embodiment.

FIG. 34 is a simple block diagram of a method for performing a scan and search operation in accordance with an embodiment.

### DETAILED DESCRIPTION

Various embodiments enable a computer, such as a mobile phone, tablet, etc., to assist users to effectively consider their dietary interests and help them to select foods that meet their needs. By using an application, or app, a user can locate information regarding a specific product which is provided to them in a manner that easy to understand and tailored to their preferences. Other functions allow the user to generate and update shopping lists, plan meals, setup fitness routines, and access online information regarding relevant topics.

Everyone can benefit from the access to nutritional data provided by various embodiments to improve their lives and their relationship with one of the most primary human needs—food. By providing an interface with design emphasis placed on legibility, simplicity, and ease of navigation, even people who have not used the interface before can quickly access important nutritional information. The interface is usable by all ages, experience levels, and demographics.

The interface lets users screen food products based on their needs and to track those foods both for purchase and for consumption. Additionally, users can track health and wellness information (e.g., work out routines, hydration, etc.). Meal plans can be provided based on the individual needs of the user. As an additional benefit, users are presented with advertisements for products that meet their stated needs. This helps advertisers avoid unnecessary expenses on ads which a user would not be interested in while also giving users a more effective ad experience free of excess clutter.

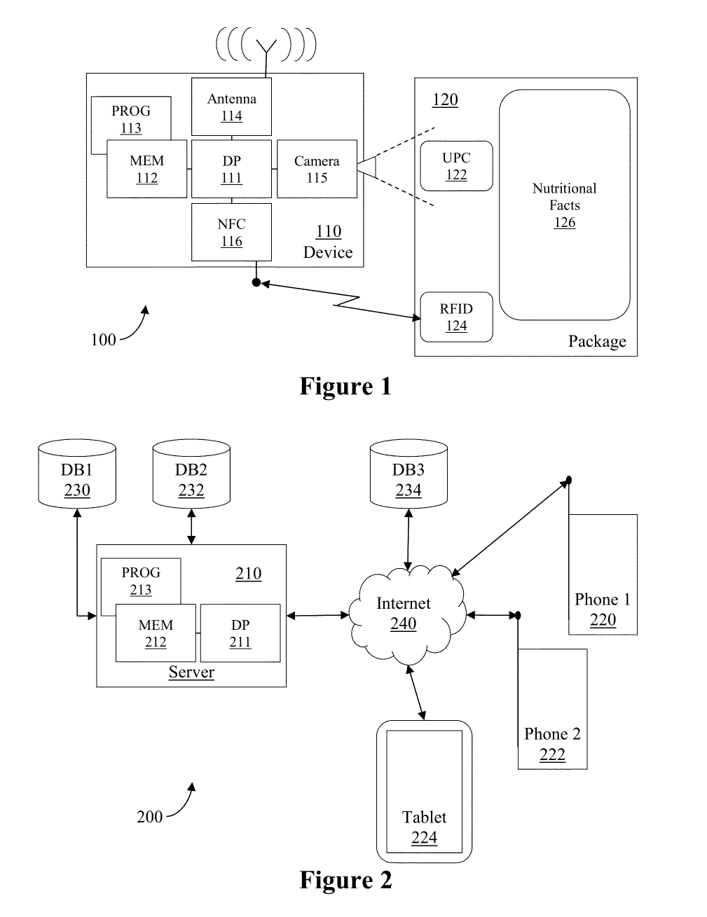

FIG. 1 shows a block diagram of an exemplary device 110 that is suitable for use in practicing various exemplary embodiments. In the system 100 of FIG. 1, the device 110 includes a controller, such as a data processor (DP) 111, a computer-readable medium embodied as a memory (MEM) 112 that stores computer instructions, such as a program (PROG) 113, and a suitable communication interface, such as a radio frequency (RF) antenna 114. The device also includes a camera 115 and a near field communication (NFC) antenna 116.

The package 120 shown has a nutritional facts label 126, a product barcode, such as a Universal Product Code (UPC) 122, and a RFID 124. Various embodiments may omit one or more elements, for example, older packages may omit the RFID 124. The device 110 may use the camera 115 to scan the UPC 122 and/or take a picture of the package 120 or nutritional facts label 126 to gather information about the product. Likewise, the device may scan the RFID 124 using the NFC antenna 116.

In general, various embodiments of the device 110 may include cellular telephones, tablets, computers, digital cameras, gaming devices, music players, as well as other devices that incorporate combinations of such functions.

FIG. 2 shows a block diagram of a computer system 200 suitable to practice an embodiment. As shown in FIG. 2, the server 210 includes a controller, such as a data processor (DP) 211, and a computer-readable medium embodied as a memory (MEM) 212 that stores computer instructions, such as a program (PROG) 213. The server 210 is connected to a plurality of local databases, such as a profile database DB1 230 and a product database DB2 232. The server 210 may communicate via the internet 240 with a remote database, such as coupon DB3 234.

Data stored in the databases 230, 232, 234, such as user profiles or product information, may be encrypted. Access to the databases 230, 232, 234 may also be restricted by access controls or other means to prevent unwanted third party access without proper authorization.

A user on any one of various devices, such as Phone 1 220, Phone 2 222, and the Tablet 224, may log in to the server 210 in order to access their account. As a non-limiting example, a user may use a Tablet 224 to plan out a series of meal and set up shopping lists when at home. Then, when the user is out at the store, the same user can access the shopping lists using their phone, Phone 1 220. Communications between the server 210 and the user devices 220, 222, 224 may be encrypted.

A program may include instructions that, when executed by an associated DP, enable the devices 220, 222, 224 and/or server 210 to operate in accordance with an embodiment. That is, various embodiments may be carried out at least in part by computer software executable by a DP of one of the devices 220, 222, 224, by computer software executable by the DP 211 of the server 210, by hardware, or by a combination of software and hardware.

The MEM 213 and/or the databases 230, 232, 234 may be of any type suitable to the local technical environment and may be implemented using any suitable data storage technology, such as magnetic memory devices, semiconductor based memory devices, flash memory, optical memory devices, fixed memory and removable memory. The DP 211 may be of any type suitable to the local technical environment, and may include general purpose computers, special purpose computers, microprocessors and multicore processors, as non-limiting examples. A communication interface (e.g., one used to access the Internet 240) may be of any type suitable to the local technical environment and may be implemented using any suitable communication technology such as RF systems, including the use of near field communication systems, optical communication systems, such as infrared systems and/or optical scanning systems, induction communication systems, wired connection interfaces, such as an Ethernet connection or a fiber optical connection, or a combination of such components. Additionally, the communication interface may be a bidirectional interface using transmitters, receivers, and/or transceivers, or, as appropriate for the embodiment, a unidirectional interface.

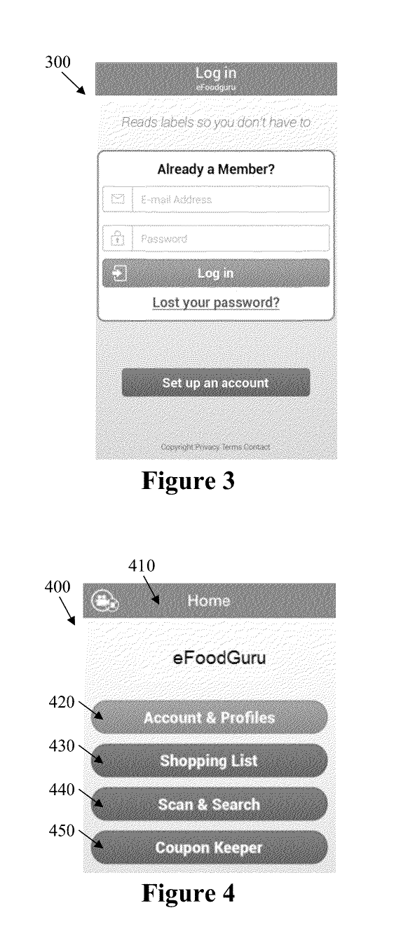

A non-limiting embodiment is described below with reference to FIGS. 3-32. In this embodiment, an app (having a user interface (UI)) is provided which allows users to access their account, profile, lists, planners, etc. The app may be run on any suitable electronic device, for example, a phone, tablet device or personal computer.

When accessing the service, a user is presented with a log in screen 300 such as shown in FIG. 3. The user can provide their log in information, such as an email address and password for example, or, if they do not have an account, they can set up a new account.

Once the user logs in they are presented with a home screen 400 for the software app such illustrated in FIG. 4. Features are accessed through the home screen 400 of the app, for example, profile, lists, planners, etc. The home screen 400 can also be accessed from other pages in the app, so that the user can navigate to it easily via a slider on these pages.

Furthermore, the user can navigate back to the home page by hitting the “back” button on the phone. If the user slides the home screen 400 open by accident, the back button will return them to the page they were last viewing (hiding the home screen options again). A header at the top of the page (the title of the page, for example, header 410 titled “Home”) can also function as a back button (a “back” arrow icon may also be present as well). The “back” button may also change functions based on the recent behavior of the app, for example, when the user has navigated through several screens, the “back” button may simply take them to the last viewed screen. Additionally, if the device includes a built-in back button feature (e.g., as a physical button) then the app may be configured to work with it.

In this non-limiting embodiment, four options are presented on the home screen 400. These options are as follows: “Account and Profiles” 420, “Shopping List” 430, “Scan or Search” 440 and “Coupon Keeper” 450. Other embodiments may include additional options, for example, a “Planner” button (not shown).

The “Account and Profiles” button 420 allows the user to access their account settings and the settings of different profiles. Selecting this button 420 takes the user to the Profiles screen 800, shown in FIG. 8. From this screen 800 account settings can be accessed.

The “Shopping List” button 430 allows the user to access the shopping list functions with which they can generate new shopping lists, view old shopping lists, access the old shopping lists, and access data of items in those lists. Selecting this button takes the user to the Shopping list screen 1700.

When present, the “Planner” button allows the user to access a meal planner journal 2500 and/or a fitness planner journal which includes analytical tools and daily tallies (of nutritional variables). This brings up a pop-over with a list of all profiles and dining groups. The user selects one and enters the meal planner 2500 for that profile or group. When the fitness planner is selected it triggers a pop-over menu to access their exercise planner and journal.

In one, non-limiting embodiment, the “Planner” button excludes the fitness planner journal. Selecting the planner and journal button takes the user to their meal planner and journal 2500. In an alternative, non-limiting embodiment, the “Planner” button excludes the meal planner journal. Selecting the planner and journal button takes the user to their fitness planner journal.

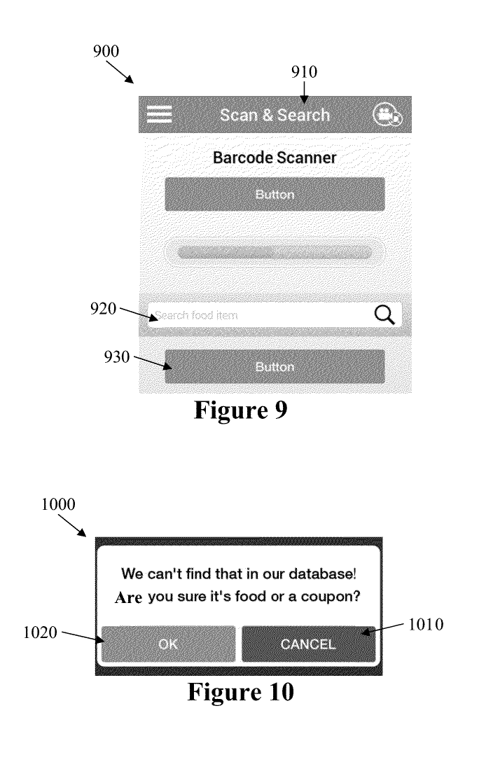

The “Scan or Search” button 440 allows the user to scan and/or search for food products, view the compatibility of those products with their personal profiles, and to add those food products to their shopping lists or meal planner. Selecting this button takes the user to the Scan and Search screen 900 in FIG. 9.

The “Coupon Keeper” button 450 takes the user to the section of the app that archives coupons and promotions that the user has received from the app for products that they have scanned in or that the user has found by looking at advertisements on the app. In another non-limiting embodiment, the coupon keeper can also maintain data on paper coupons scanned into the app.

FIG. 5 illustrates a registration screen 500 for account creation. Users may sign in using a website or using the app. Upon first opening the app, the user is prompted to sign in or create a new account. The account creation screen 500 is the first page they see upon selecting “create new account.” This screen 500 helps the user set up various settings and preferences, for example, username, password and email address.

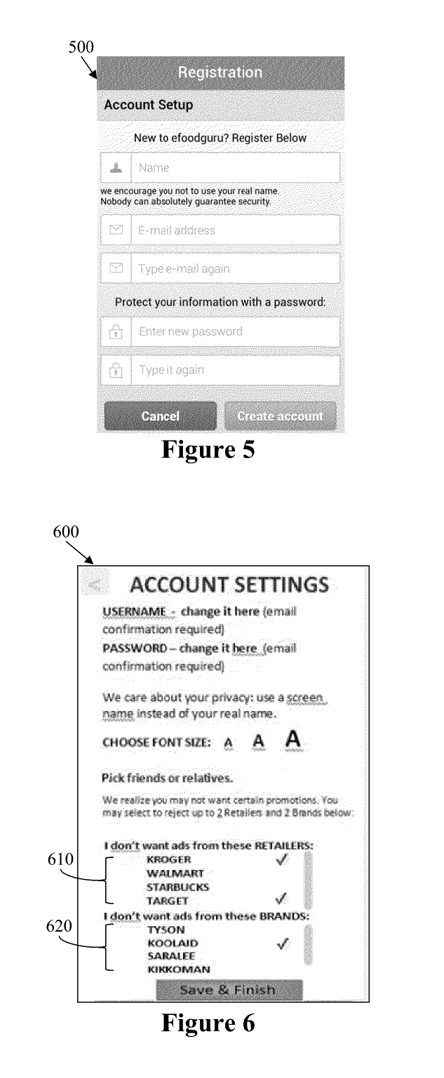

An account settings screen 600 for the app is illustrated in FIG. 6. The account settings screen 600 is where the user may change all settings associated with their account. It may include the following fields: username, password, email address, and preferred font size. Some preferences, such as the font size, may be initially set based on a default setting.

In one non-limiting embodiment, the user may select between a display font of small type size, medium type size, and large type size. In other embodiments, additional font sizes may be presented. Alternatively, the app may access general setting on the device for use as default settings on the app.

In another non-limiting embodiment, the user may also select a preferred language, preferred units of measurement, e.g., metric or US standard, etc.

Additionally, the user may be presented with opt-in/opt-out options for various promotions. As show in FIG. 6, the user is provided with the option of opting-out from ads of two retailers in list 610 and two brands in list 620. In further embodiments, the user may be allowed to select more (or less) retailers/brands. Also, the user may opt-in/opt-out of promotions regarding specific products and product categories, such as dairy products, soy sauces, etc.

As noted above, different devices may sign into the same account. This includes computers, tablets, and smart phones, each of which may have their own identity on the website and app. The account may include a number of profiles; however, each device may turn on or off different profiles. This controls what is seen in the product report as described in further detail below.

As a non-limiting example, a mother has four food allergic children. One of them grows up and gets a phone. He isn't shopping for his siblings, and only wants information about what he is allergic to in the foods he scans. He can deactivate (turn off) his sibling's profiles on his device, so that he will not receive information in the product report that is pertinent to them. His mother, on her device, has his siblings' profiles activated (turned on), and will see information pertinent to them. If the child needs to pick something up at the grocery store, he can turn on his siblings' profiles and get accurate information on what they can or cannot eat.

The information for an account and its profiles syncs over the internet across all devices with that account whenever updated or changed. This includes the meal planner, profiles and preferences, and shopping list information. For example, the system may push out updates to a profile to local copies stored on the various devices, for example, when the user logs into the system. In one alternative embodiment, changes may be made to a central database so that when a user accesses their account the information in that account is the most recent.

As described in more detail below, profiles include a specific collection of dietary preferences, a meal planner, and a fitness planner. An account may have multiple profiles. The shopping history and account information are tied to one account—they do not vary based on the profile. Accounts may be viewed as connecting profiles for families and groups of people (or individuals) while profiles may be viewed as individual within the groups.

After the account has been set up, the user can return to the account settings screen 600 in order to update various preferences.

Once a user has established an account, they can populate it with one or more profiles. All profiles are tied to an account, regardless of what device they are created on. Additionally, the user can access profiles of other users.

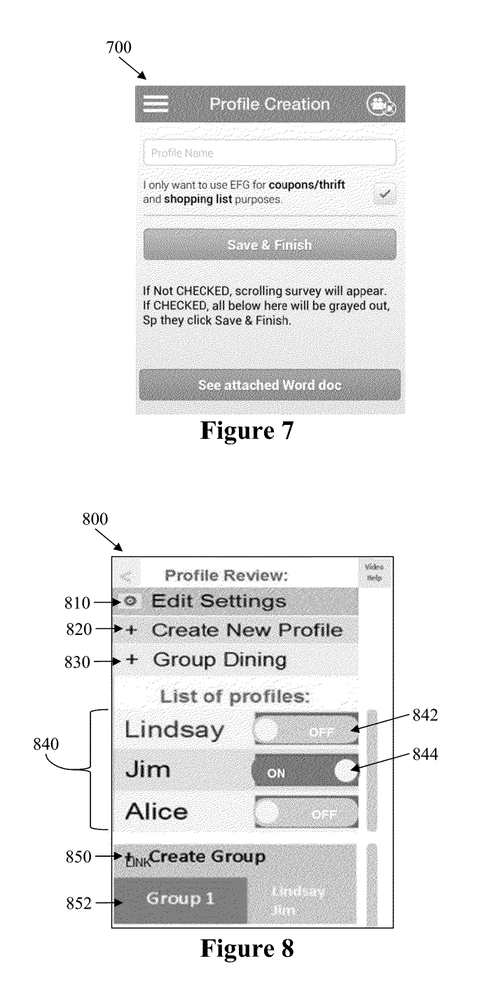

FIG. 7 illustrates a profile creation screen 700. The profile creation screen 700 is where profile preferences may be chosen. This screen 700 may be the same during profile creation and when editing profiles from the Profiles screen 800. Profile creation consists of setting a series of preferences regarding what the user (or person associated with the profile) would like to know about their food.

The user may be taken to the profile creation screen 700 immediately after creating an account. Users may also access the profile creation screen 700 at a later time in order to create new profiles for their account.

When creating a profile, the user may be asked a series of questions regarding the profile. This is where the user can set various diet and food choices for the profile.

In one non-limiting embodiment, the user is first asked to enter a profile name. The profile name does not need to be unique. While account names may be unique, the profile names within various accounts may be repeated, for example, different accounts may have profiles named “Bob” but there may be only one account named “Bob.”

In a further embodiment, profiles names may not be duplicated within a single account. Alternatively, when a duplicate profile name is entered, the system may present a warning and prompt the user to either change the profile name or to confirm the use of the same profile name.

The system allows a user to enter a profile code. This code links an existing profile, for example, one of a friend or one created by a healthcare practitioner for the user. This allows the user to either create a duplicate profile, which they can then modify, and/or to link the new profile to the existing profile.

In one example, a mother wants to share her children's profiles with their grandmother, who is buying food for the children. The mother emails the grandmother the information about eFoodGuru and the unique profile codes of the three children. The grandmother enters them one at a time in order to replicate the profiles of each child in her own account. Using these profiles she can shop effectively for all of them.

In one non-limiting embodiment, each profile created is associated with a unique code, for example, an alpha-numeric string, a number, etc. Using the code populates all of the preferences for the new profile with the preferences of the profile associated with the code. The new profile may then use the same code. If the user changes the new profile, the new profile may be assigned a new code.

For example, a person is given a profile code for a special diet by a friend. This first person is avoiding wheat. After entering the profile code shared with them by their friend, they add wheat to the list of ingredients they would like to avoid. This triggers the account to be given a new profile code. If they give this new code to someone else, it will exactly recreate the diet they were given, plus the modification to avoid wheat.

In another non-limiting embodiment, entering the profile code prompts a user associated with the profile to approve access to the profile. Once that user approves the access, the new profile is populated with the profile's preferences.

In a further non-limiting embodiment, use of the profile code links the new profile and the existing profile. When the existing profile is changed these changes may be made to the new profile (either automatically or after notifying the user of the new profile). For example, if the person associated with the existing profile changes their personal profile to a vegan diet, this information can be reflected in the new profile even after the new profile had already been created. Alternatively, when the owner of the existing profile makes a change to their profile, the new profile is kept the same (e.g., without the change) and a new code is assigned to the new profile.

As noted above, the profile preferences may be setup by responding to a series of questions. The questions may include asking the user if the profile is to follow an established diet. Such diets may include the South Beach diet, the Ketogenic diet, the Atkins diet, or the Zone diet, as well as many other diets. The server 210 may include information for each diet recorded. Additional information for a diet may be accessed by the user, for example, by selecting a “more info” button presented next to the name of the diet.

If the user selects a diet, the system automatically sets the profile preferences similarly to a profile code. Alternatively, selecting a diet operates as an overlay for the profile preferences. Changes to the profile preferences are then recorded in the profile preferences. This way, the user may then change or remove the selected diet for the profile without losing their changes.

When conflicts between the diet and the profile occur, the system can either defer to the diet or the profile. For example, the Paleo diet may include fish, if the user sets their preferences to avoid shellfish (e.g., due to a religious restriction), the system may defer to the preferences and avoid shellfish even though it is accepted in the Paleo diet. In another example, the South Beach diet may prescribe 30 grams of carbohydrates a day. The user may have an existing preference for 45 grams per day. The system may then override their preferences in order to follow the diet's more restrictive settings.

Additionally, conflicts may be resolved in a number of ways. The user may be notified of any conflicts when making changes to their profile and/or selecting the diet. The user may then decide which preference they wish to keep. Another way may be for the conflicting preferences to be compared and the system automatically selected the ‘more restrictive’ option, e.g., automatically selecting 30 grams of carbohydrates per day rather than 45 grams or automatically excluding fish. Preference conflicts may also be resolved based on an additional flag, such as an override flag. This flag may be set internally by the system or as an option for the user. For example, when selecting a preference for ‘no fish’, the user may select an ‘always’ button.

Profile preferences may also be set individually. These may be arranged in categories which are presented one at time, for example, ‘Foods to avoid’, ‘Nutrition to track’, etc. Each category may include a drop-down menu and check-box-type options. When check-boxes are selected, further options cascade beneath them, and when de-selected, these disappear. As another non-limiting embodiment, the profile preferences may be arranged in a page format where selections on one page may impact which pages are shown next and/or the content of subsequent pages.

The user may be presented with a question, such as “Are there any foods you would like to avoid or limit?” If they select this option (e.g., by checking an associated box), a list of ingredients or foods that can be avoided can drop down below it. When a food item/type is selected, ingredients associated with it can drop down beneath it. The list of ingredients may include hierarchical relationships between the ingredients so that selecting one ingredient may automatically select additional ingredients. Each of ingredients may be presented with a check-box next to it to indicate the ingredient is being tracked. When de-selected, this will result in the application not tracking that particular ingredient. Alternatively, a selected check-box may indicate that the application not tracking that particular ingredient.

For example, if the user selects “Pork” a list opens with the following: Pork, Pig, Ham, Bacon, Lard, Pork by-product, Porcine, Hog, etc. Each of these is automatically selected when they select “Pork.” De-selecting pork also de-selects all the ingredients below it. So long as any of the ingredients below are selected, “Pork” is also marked as selected.

The system may include various food avoidance lists. Some of these lists can be open for editing within the profile while other lists may be proprietary and users are not allowed to edit them.

Another series of questions may be presented to ask the user what food intake they would like to track. The food intake sub-groups may include ingredient categories, specific ingredient and/or metabolic reactions to food. For example, the user may track carbohydrates, salt/sodium, hydration, fat, calories, protein, cholesterol, food groups (e.g., vegetables, fruits, meats, etc.) and blood sugar.

After selecting a food intake sub-group, the user is presented with questions specific to the sub-group. This also allows the user to select target values, for example, minimum intake, maximum intake, etc. In order to input this information, the user may be presented with a slider, a data entry box and/or a ladder of choices (e.g., very low, low, moderate, slightly elevated, etc.). The UI may also present recommended values (for example, by default or upon request by the user).

As a first non-limiting example, if the user selects the blood sugar sub-group, they may be presented with the options to limit foods with: “added sugar,” “foods high in carbohydrates” and “foods high in sugar.” Selecting “foods high in carbohydrates” brings up a list of options:

1) “Maximum of:” with a data entry box,

2) “Very low (3-10%),”

3) “Low (10-20%),”

4) “Moderate (20-40%),”

5) “Slightly elevated (40-60%),”

6) “Elevated (60-80%),” and

7) “Very high (80-100%).”

These percentages represent the percent of calories from carbohydrates which may be determined by the following equation:

%=(4*(# grams of carbohydrates−# grams of fiber)/(total calories)) (1)

Selecting “foods high in sugar” brings up a similar list of option based on the percentages of calories from sugar. This value may be determined by the following equation:

%=(4*# grams of sugar)/(total calories)) (2)

As another non-limiting example, if the user selects the hydration sub-group the user is asked to “select an intake of water from 0.4 ounces per pound of body weight to 0.7 ounces per pound of body weight.” Their selection can be multiplied by their body weight to give them a recommended fluid intake.

When entering percentages of calories in the diet from various macronutrients (e.g., fats, carbs and proteins), the system may provide a warning when the total of the different percentages exceeds 100. When determining calories the system may use the following values: 9 calories per gram of fat, 4 calories per gram of carbs (excluding fiber) and 4 calories per gram of protein.

Some food intake sub-groups may share similar questions (e.g., the blood sugar sub-group and the carbohydrates sub-groups). After filling out the questions for one sub-group, when the user selects a second sub-group those questions may be automatically filled out to match the earlier given responses. In one non-limiting embodiment, these automatically filled selections may not be deselected without updating the profile preferences.

The series of questions presented to the user may also include questions regarding nutritional facts they would like reported from products reviewed. Based on the answers to these questions, when the user looks up a product, for example, by scanning it, the system can prepare a tailored product report focused on the profile's listed interests. This allows the user to quickly assess the product and see how it fits within their goals.

The user may be provided with a list of which nutritional facts they would like to have reported. This list may include calories, protein, fats, percentage of calories from fat, vitamins (e.g., Vitamin A, Vitamin D, etc.), minerals (e.g., Calcium, Zinc, etc.), allergens (e.g., nuts, eggs, dairy, etc.) and the like. The user may also be provided with the option to track additional information, such as “organic,” “GMO free,” etc. This additional information may be indicated as a preference or as a strict requirement, e.g., the user may select an “I prefer organic foods” or an “I only eat organic foods” option.

Additionally, the nutritional facts may include a glycemic index estimate. Using a glycemic index estimator the system can automatically generating a report with an estimate of the product's expected impact on the user's blood sugar. The estimator may perform the calculation itself, for example, on the user's phone using an equation based on the contents of the food, or the estimator may look up the information, for example from the server 210.

Various options may be set automatically based in response to other questions. For example, if the profile has been set up to track caloric intake then the nutritional information regarding calories may be selected by default. If the user were to try to deselect an option, the UI may inform the user why the option was selected, for example, with a message: “These nutrition facts have been selected based on your choices above” and/or by indicating the earlier selected preference.

The user may also be presented with questions regarding the person associated with the profile. This information may include age, weight, height, sex, etc. The user may also input information regarding the daily activity level of the person. For example, the user may choose from the following options: sedentary (minimal exertion throughout the day), light activity (light physical exertion throughout the day), and heavy activity (heavy physical exertion throughout the day). Additional information may be recorded regarding any conditions the profile may have, for example, if the profile relates to a person that has diabetes, celiac disease, etc.

Another question which may be asked requests the default serving size for the profile. This may be represented as a number from 1 to 10, as a relative indicator (e.g., small, medium, large), etc.

Once the user has finished the series of questions, they may be presented with a “save and continue” option. Other options may be presented to allow the user to review the profile before saving and/or to exit without saving. When the user completes the first profile associated with the account, the user may be asked if they would like to make another profile.

The user may also set up additional options regarding the account. As a first example, the user may be allowed to set options for advertisements. In one non-limiting embodiment, the user can opt-out of promotions and advertisements from specific brands, retailers/etailers, etc. The system may limit the user to a maximum number of opt-out choices, e.g., no more than two brands and two retailers/etailers. As another example, the user may select to turn off GPS tracking, alerts, etc.

FIG. 8 illustrates a profile review screen 800. This screen 800 allows the user to manage profiles, for example, by creating new ones, or modifying existing ones. The user may also create and manage groups of profiles. As shown, an “Edit Settings” button 810 may be used to access the account settings page 600, where the user can edit any information about the account as a whole. The “Create new profile” button 820 can be used to take the user through the profile creation process, as detailed above. Selecting an individual profile from a list of profiles 840 (e.g., by clicking its associated name) opens that profile to its preferences, so that the user can edit the profile name, profile color scheme, and other profile preferences. The user can also access the meal planner for that profile.

The “On/Off” buttons 842, 844 next to the profile entry may be used to turn “on” 844 or “off” 844 (activate or deactivate) each profile. Profiles that are on (activated) have their preferences included in product reports. Profiles that are off (deactivated) do not.

The group dining button 830 activates a function that allows users to create meals in the meal planner that are added to multiple profiles from one entry in the group's meal planner. The groups 852 may be displayed at the end of the profiles and numbered, such as “Group 1,” “Group 2,” etc. Alternatively, the user may customize the name of the groups.

The “Create new group” button 850 allows the user to form new groups. By selecting this button 850, the user may be presented with a pop-over menu listing all profiles associated with the account. The user can then select which of the profiles are to be included in the new group. In one non-limiting embodiment, the user may be notified when a new group is being generated with the same profiles as an existing group.

In a first example, two users, Jack and Suzy, eat dinner together sometimes. They select create new group and select both of their profiles. They can leave out other profiles, even though those additional profiles are in the same account, because they aren't eating with them. When a user on the account enters the meal planner and selects “group 1,” any entries made to the group is made in both of their individual profiles. If they wish to edit these entries later, they may do so in their individual profiles. In one non-limiting embodiment, changes made in a meal planner for a specific profile do not carry over to other profiles in groups of which that profile is a member.

The meals for a group are the aggregate of all the meals of the individual profiles in that group. The foods in each meal are the aggregate of all the foods for that meal in all the individual profiles. When a meal is created for the group, the same meal is populated in all the profiles. If a profile does not have that meal, the meal does not populate in their meal planner.

As one example, Jack and Jill are in a group. Jack eats breakfast, lunch, dinner, and a snack. Jill eats breakfast, lunch, and dinner. The meal planner for their group displays: breakfast, lunch, dinner, and snack. If Jacks adds a “snack” meal entry to their group planner, the meal is added to the meal for his meal planner only. If Jill adds a meal entry to their group planner for dinner, the entry populates to dinner for both of their individual meal planners.

The system access allows users to easily track their diet and provides users with information pertinent to them based on the profile preferences. When a product is scanned, the system accesses a food product item, or simply ‘item,’ from a database (either internally maintained by the system or an external database). The item includes a number of properties associated with the product. These properties may include the nutrition facts and the ingredient list that a food manufacturer can publish with the USDA. The total number of properties of an item can be adjusted based on the specific needs of the system.

FIG. 9 illustrates a scan and search screen 900. This screen allows a user to look up a product in order to see a product report for it. The user may scan information identifying the product or they may search for products using a text search 920.

In this non-limiting embodiment, the user can scan the product's bar code, e.g., using a camera on a phone. Based on information from the bar code, such as a UPC code, the system can access a database and retrieve the product information. In further embodiments, the user may be able to use other means to quickly identify the product, for example, by reading an RFID chip/interface and/or by sending a photo of the product/package. Using a NFC scanner, the phone may be able to receive the UPC code for the product or directly access the nutrition facts and the ingredient list, e.g., from an RFID interface on a promotional display. Processing a photo of the product, for example, by using character recognition and/or image comparison, allows the system to identify the product from an image.

If the user has scanned a product or coupon from a brand or manufacturer they have excluded, the user may be reminded that they have excluded themselves from that brand's advertisements. They may then be prompted to allow ads from that brand or manufacturer.

Once the product is identified, the app can query a database or data service, such as a local database, Food Essentials or another third party database with an API data stream, for the food information. The system may also access additional databases in case one database does not have all the relevant information. The information from the various databases can be combined to create a full, food product item which can then be stored in a local database for future reference. The app also queries a database to retrieve any discount coupons offered for the product. The information within the databases which is relevant to the user can be returned on the product report screen. When accessing additional databases the UI may provide a notification to the user indicating that an in-depth search is being performed.

Additionally, a user may scan a coupon. The app performs a search to identify relevant coupon information and any associated products, for example, by querying a grocery server application programming interface (API). The app may then display a list of the associated products to the user. The list may also identify foods on a shopping list or meal plan. The coupon information may also be stored for future reference, for example, in a coupon keeper database.

If the product or coupon cannot be identified or a database search provides no results, the user may be provided a notification. FIG. 10 illustrates a failed search pop-over screen 1000. The user may press the ‘CANCEL’ button 1010 to return to the Scan & Search screen 900 and either try scanning again or performing a manual search.

While many food product items may be stored in databases, new food product items may also be added by users. The user can input the nutrition facts and ingredient list and the system can prepare a product report based on this information. These user-defined items may be flagged for verification before being added to an internal database for access by all users or they may be added automatically and the information confirmed later.

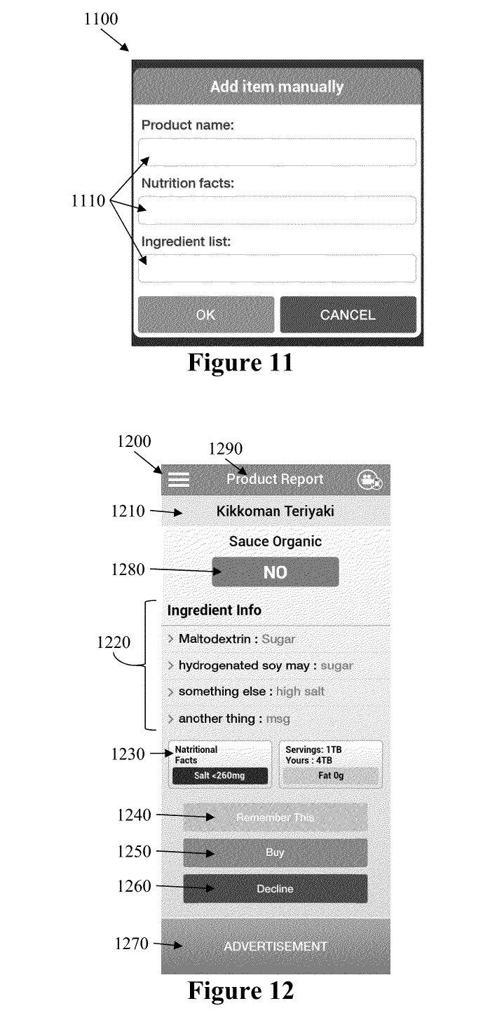

FIG. 11 illustrates a screen 1100 to assist adding an item manually for the software application. The user may be directed to this screen 1100 by pressing the ‘OK’ button 1020 in FIG. 10. As shown, the user is provided text fields 1110 to add the product name, nutrition facts and ingredients. Alternatively, the user may be provided with a menu of nutrition facts, e.g., calories, vitamins, etc. Once the information has been entered it may be combined with additional data, e.g., a UPC code scanned earlier.

Results from searching for a product by using a text search may be provided using a search results screen. This may be set up so that a search field with the search terms used appears at top of page and results are provided beneath it. This screen may include options to add the found products to a shopping list or a meal planner. Users can also highlight items, and select a “get info” button to review the found items.

The search field 920 may also be used to perform additional searches, either within the results provided or as a new search. For example, the user can replace the terms used with a new search and press a “search” button 930.

The search results may be compiled from multiple database searches. As a non-limiting example, the system may check an internal database and then supplement the results by searching the Nutritionix database. The combined results may also be sorted based in part on the source of the results, such as, where results from the internal database are closer to the top of the list while results from remote databases are closer to the bottom as one example.

If the search function is activated via an active shopping list or via the meal planner, the user can return to that screen upon making their selection of the search results and viewing the product report screen 1200 in FIG. 12, or by hitting a back button (or the title bar 910). In other words, it can return them to wherever they had come from rather than returning them to the home screen 400.

If there is a null value in an information field for an item (e.g., the manufacturer did not report any data for that particular field of information, such as vitamin C, vitamin A), the result can be reported as blank (rather than zero or null), after querying all available databases and APIs. The user will be offered an option to take a photo of the ingredients list or nutrition facts from the label and send them to the system. This photograph can be analyzed with photo-recognition technology to read it. A product report based on the updated information may then be returned to the user. While analyzing the photo and waiting for the report, an app loading screen can say, “Analyzing photo” with a loading screen graphic.

Holding down an item on the results list can cause a pop-over to appear asking the user to confirm deletion of the item. Lightly tapping an item selects and highlights that item, including deselecting/un-highlighting any previously selected items. Selected items are the subject of any buttons or functions selected, such as “get info,” “add to list,” “add to meal planner” or the compass rose.

Selecting the “get info” button takes the user to a product report screen for the selected item. The system may perform a search for the selected item once the “get info” button is selected. Alternatively, the system may perform a search for the food product info for each item on the list. Any items which do not have food product info available may then be marked accordingly, for example, by greying out that item on the results list, by greying out the “get info” button when that item is selected or by replacing the “get info” button with an “add info” button when that item is selected.

The user may use up/down arrows to change the quantity of items to be used when adding an item to a list or meal planner. The quantity to be used and the arrows may be provided whenever an item is selected or whenever the item is to be added to a list or meal planner, for example, in a pop-over display.

FIG. 12 illustrates a product report screen 1200. This screen 1200 is displayed to the user when they scan a product or select “get info” from an item in a shopping list, meal planner or search result list. The product report for an account is an aggregate of all information of interest to all active profiles within that account.

As a first example, Jack and Jill share an account. Jack wants to know about protein levels in his food. Jill is gluten-intolerant and wants to know about gluten in her food. The product report they both receive when using their account will show them both gluten and protein information while both their profiles are “on.” If Jack goes out of town and Jill turns off his profile, she will only see gluten information, and not protein information. Likewise, if Jill goes out of town and Jack turns off her profile, he will only see information on protein, and not on gluten.

As another example, a mother of four, food allergic children has an account with profiles for each of the children. One is allergic to wheat, one is allergic to gluten, one is allergic to peanuts and one is allergic to egg. She turns on all four profiles. When an item is scanned, it reports the presence of any of these ingredients for any of these four foods simultaneously. When the wheat allergic child goes to summer-camp, she turns off that profile. Now, only the presence of ingredients from the remaining three (egg, peanut and gluten) will be screened for. After the child returns, she turns on their profile, and now all four are screened for, as previously.

The product report screen 1200 shows the user ingredient information, nutrition facts, and the compatibility of the product with their stated goals. The product report screen 1200 can include the following items: a product report header, a product name 1210, ingredient info 1220, nutrition facts 1230, additional information (e.g., “organic?”), a “remember this food” button 1240, a purchase button 1250, a decline button 1260 and advertisements 1270. The ingredient info 1220 indicates whether the product contains any ingredients the user wants to avoid or track.

These items may or may not be displayed as static images. For example, the product report header 1210 may not change while the nutrition facts 1230 may be scrolled through. Additionally, the advertisement 1270 may be changed regularly, for example, every 2 minutes, or scrolled through by the user.

The product report screen 1200 also provides a recommendation 1280 for the product based on the user's preferences and goals. As shown in FIG. 12, the user is presented with a “NO” recommendation.

If there are no ingredients associated with foods the user wishes to avoid or limit, they may be presented with a “YES” recommendation. They may also be provided a notification that the ingredient information does not contain ingredients the user is avoiding or limiting in their profiles. Likewise, the user may see a “YES” recommendation if the product is organic and they have indicated a preference for organic food in their profile preferences (when all other restrictions are met).

A “NO” recommendation is provided when an ingredient is present that is or contains a food the user wishes to avoid. A message may appear to notify them of the presence of this ingredient and/or explain which ingredient is or contains the food the user wishes to avoid. Likewise, the “NO” recommendation may be provided if the food is high in an ingredient the user wishes to limit. As one non-limiting example, a person wants to avoid sugar. Maltodextrin, a type of sugar, is listed in the ingredients of a product. The app can display a message stating: “NO, Maltodextrin=sugar.” Similarly, if the profile preferences indicate only organic food, products which are non-organic are given ‘NO” recommendations.

In addition to “YES” and “NO” recommendations, the system can provide “CAUTION” recommendations. This can be used whenever an ingredient is present that might be or contain a food being avoided. For example, a person wants to avoid MSG. Natural flavorings, which may contain MSG, is listed in the ingredients of a product. The app states “CAUTION: natural flavorings may=MSG” in the ingredient report section. Similarly, products which are non-organic may be given a “CAUTION” recommendation if the profile preferences indicate organic food is preferred.

Explanation messages may be presented as part of the product report or the messages may be displayed, for example, in a pop-over window, when the user selects the recommendation 1280.

The nutritional facts information 1230 provided is tailored to the profile preferences for the account. The user is shown any nutrition facts selected in their profile preferences. That way, the display contains the facts relevant to any active profiles.

This information may be based on the nutrient and calorie content of the food and the user's calorie and nutrient goals. The nutrient/calorie content is compared against the daily goal for each profile. As a non-limiting example, the food may be categorized as ‘high’ in a nutrient, ‘low’ in that nutrient or neither. This categorization may be done using the following equations:

((calories per serving*portion size)/daily calorie goal)=X (3)

((nutrient per serving*portion size)/daily nutrient goal)=Y (4)

In this non-limiting example, if Y>X by 10% (e.g., when Y/X>1.1), the food is categorized as ‘high’. If Y<X by 15%, the food is categorized as ‘low’. In another non-limiting example, the categorizations may be weighted or calculated using different equations/threshold values, for example, if the nutrient is sugar, the food is categorized as ‘high’ when Y is greater than X by 5% (or Y/X is greater than 1.05).

As an example, a user has a sodium goal of 1000 mg per day and a calorie goal of 2000 calories per day, and their portion size is 4 servings. They scan a food that has 200 mg of salt and 400 calories per serving. The value for X is determined: 400 calories×4 servings/2000 total calories for the day=0.8. The value for Y is also determined: 200 mg salt×4 servings/1000 mg total salt per day=0.8. In this case, X is equal to Y: Y/X=1. Since Y does not exceed X by 10% and X does not exceed Y by 15%, the system would not report a ‘high’ or ‘low’ value for this food. Later the user scans another food which has 500 mg of salt and 200 calories per serving. X is now 0.4 and Y is 2.0. Since Y is 500% of X, the system would report a ‘high’ value for this food. Finally, the user scans a third item which has 50 mg of salt and 500 calories per serving. X is 1 and Y is 0.2. Y is now 20% of X and the system reports that this food is categorized as ‘low’.

When assigning a low/high category to a food for an account with multiple active profiles, the system may base the categorization on the largest serving size among the profiles. The system also uses this serving size on the product report screen. Alternatively, the categorization may be based on the largest serving size among the profiles tracking that nutrient. The system may still use the largest serving size among the active profiles on the product report screen.

If any of the features of the product, in the nutrition facts or ingredients, do not agree with the individual's profile preferences, those fields can appear at the top of the product report screen, before everything else

Items shown in the nutritional facts information 1230 may be color coded for easy reference. This coloring may be on the text or on the background for the text. Minima and maxima amounts for the nutrient can determine what color coding is given to different nutrients. As a non-limiting example, foods that are high in a nutrient that the user has selected a maximum for (e.g., they don't want to get too much of), or low in a nutrient they have set a minimum for (e.g., they want to be sure they are getting enough of) may be colored red. Foods that are low in a nutrient that the user has selected a maximum for (e.g., they don't want to get too much), or high in a nutrient they have set a minimum for (e.g., they want to be sure they are getting enough) may be colored green.

The order in which the nutritional facts information 1230 is presented can be customized, for example, by using an interactive display where the user can drag and drop different fields of information into the order they prefer.

As shown in FIG. 12, the product report screen 1200 includes the following buttons: “Remember This” 1240, “Buy” 1250 and “Decline” 1260. The “Remember This” button 1240 allows the user to add the item to a shopping list or meal planner in order to be purchased while the “Buy” button 1250 allows the user to add the item as a purchased item to a shopping list or meal planner. Selecting “Decline” 1260 leaves the product report screen without adding the item to any list.

In a further embodiment, the “Decline” button 1260 of FIG. 12 may be replaced with a “Cancel” button (not shown) based on how the user accessed the product report screen 1200. For example, when scanning a product from the “Scan and Search” screen 900, the user is provided with a “Decline” button 1260 since they may be considering purchasing that product. If the user selects “Get info” from a shopping list or meal planner, the “Cancel” button may be displayed.

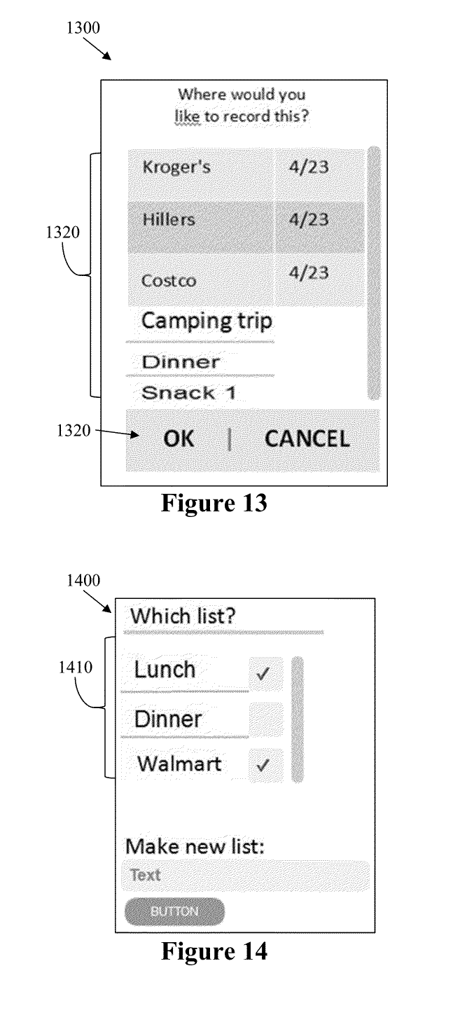

FIG. 13 illustrates a screen 1300 to assist adding an item to a shopping list and/or a meal planner for the software application. The user can access the screen 1300 by selecting the “Remember This” button 1240 from the product report screen 1200 of FIG. 12. This pop-over allows the user to select from various lists 1320 including active shopping lists and meals and snacks throughout the day. The user can select one or more of the lists 1320. The item is then recorded to those selected lists by using the “OK” button 1320.

If the user selects the “Buy” button 1250 from the product report screen 1200 of FIG. 12, the product is marked as purchased on all active lists where it is present. Alternatively, the user may select a quantity of the product and that number of the product is removed from the active lists. If the item is not on an active list the user may be prompted to add the item to a shopping list and/or a meal planner. A pop-over screen may be presented which provides a list of active shopping lists and meals and snacks throughout the day. Selecting one of these adds the item to that list or meal as a purchased item. Additionally, the user may create a new list.

Food product items (“items”) may be stored in shopping lists or the meal planner. The “add to list” and “add to meal planner” functions facilitate users moving items from one to another, so they can shop efficiently and easily track their diet. Entire shopping lists can be added to new shopping lists. Likewise, entire meals, from the pre-planned meals screen, can be added to the meal planner or to a shopping list.

The “Add to List” and “Add to Meal Planner” functions may be accessed using buttons that appear on various screens, and can be interacted with in different ways, such as, by dragging and dropping an item onto the buttons or by highlighting an item and selecting one of the buttons.

Using “Copy and Paste” functionality lets the user copy an item into a new list. One method to “Copy and Paste” involves dragging an item or list from one location on the screen and dropping the item on a new location. Dragging an item or shopping list leaves it intact at the original location (“Copy”) and duplicates it in the destination location (“Paste”). For example, a user drags and drops an item from the search results to the “add to list” button. This item is still displayed in the search results. If, while an item is selected, the “add to list” or “add to meal planner” buttons are clicked, that item (or items that it contains in the case of shopping lists and meals) will be added, just as if they had been dragged and dropped as above. For example, a user selects the item “tofu” from the search results and then hits, “add to list.” Either technique causes the system to provide a pop-over menu asking the user where they would like to add the item(s).

FIG. 14 illustrates a screen 1400 to assist adding an item marked as purchased to a shopping list and/or a meal planner for the software application. This screen provides a scrollable list 1410 of all active shopping lists and meals/snacks. Additionally, the user can opt to create a new list.

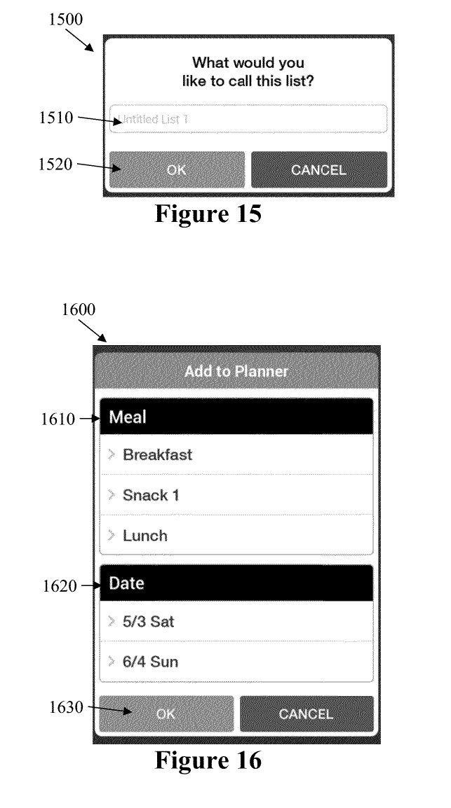

FIG. 15 illustrates a pop-up screen 1500 to assist creating a new shopping list for the software application. The user can provide a name for the new list in text box 1510 and select “OK” 1520. This creates the new list and automatically adds the items to the list.

If the item is being added to a meal planner, a pop-over screen 1600 is used to ask the user to indicate a profile or group. FIG. 16 illustrates a screen 1600 to assist adding an item to a meal planner for the software application. This screen 1600 shows a list of meals 1610 for the profile or group and a list of dates 1620. The user can select a meal and date. Selecting “OK” 1630 adds the items accordingly. In another embodiment, the date may be entered directly via a keyboard or selected from a calendar.

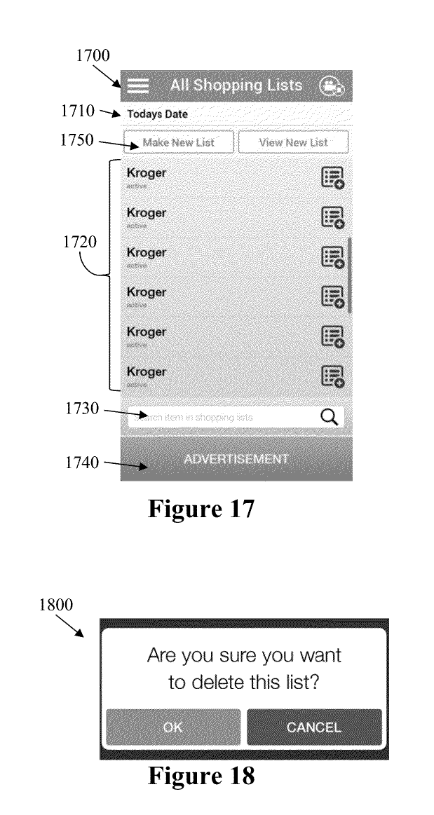

FIG. 17 illustrates a screen showing shopping lists for the software application. The “all shopping list” screen 1700 allows users to access active (current) shopping lists as well as old shopping lists. This list can be sorted in a variety of ways, such as from active to old, with the most recent to least recent in order from top to bottom; or sorted by order of creation (e.g., from the most recent at the top to least recent at the bottom regardless of the old/active status. The screen consists of: 1) the current date 1710, 2) a list of active and old shopping lists 1720, 3) a search shopping lists function 1730, and 4) an advertising banner 1740 at the bottom of the screen 1700.

Active shopping lists are for items that the user plans to purchase in the immediate future, and tracks these items while they are shopping. Clicking on an active shopping list takes the user to the active/current shopping list screen 1700.

Users can delete an active shopping list by clicking and holding down an active shopping list. This opens a pop-over 800 that asks the user to confirm the deletion. FIG. 18 illustrates such a pop-up screen 800 to confirm deleting a shopping list.

A “Search shopping lists” field 1730 is shown at the bottom of the screen 1700 of FIG. 17, above the advertising banner 1740. This field 1730 can be used to search shopping lists for keywords. This search will return food product items as results. In one embodiment, when the user selects an item from the list, they are shown the most recent old shopping list in which included that item, with that item highlighted. The user may also use the search results to add the item to a shopping list, for example, by copying and dragging the product directly to an “add to shopping list” area on the screen.

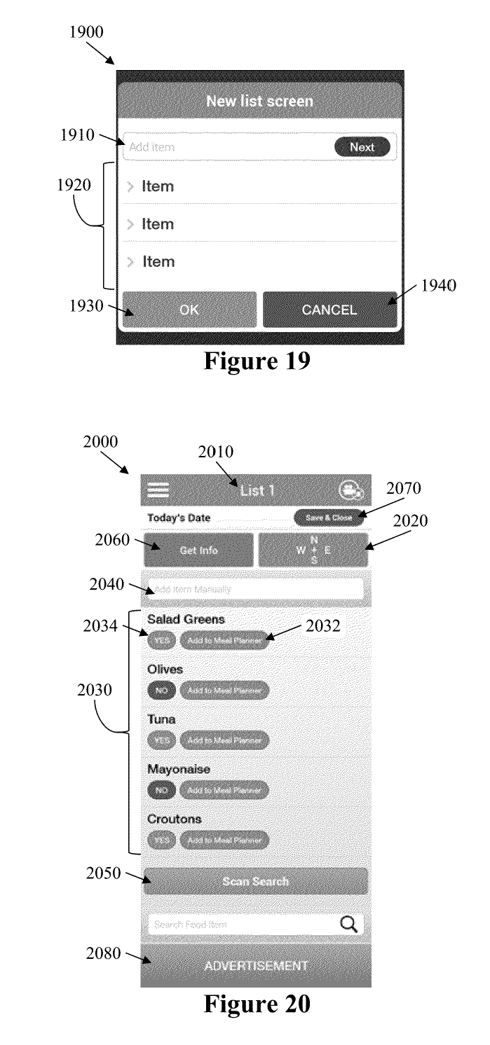

The “all shopping list” screen 1700 of FIG. 17 also includes a “Make New List” button 1750. Selecting this option allows the user to generate a new active list. FIG. 19 illustrates another pop-up screen 1900 to assist creating a new shopping list for the software application.

The pop-over 1900 asks the user to input a name for new list into text box 1910. In one non-limiting embodiment, a default name may be provided, e.g., “Untitled List 1.” Alternatively, when copying a list, a default name may be suggested which is the same as the name for the original list.

Items in the list 1920 are shown for the user to review. For example, when copying a list the items from the original list will be shown. The user may also add items directly to the list 1920 before creating the list. For example, the user may be taken to a ‘Scan and Search’ screen to add items.

Shown at the bottom of FIG. 19 are “OK”/“cancel” options 1930, 1940. The “Ok” button 1930 creates the list and takes the user to the new list's screen. The “cancel” button 1940 cancels the list creation.

FIG. 20 illustrates a screen 2000 showing an active shopping list for the software application. Selecting an active shopping list opens the active/current shopping list screen 1700. The active shopping list screen 2000 shown includes: a title bar 2010 showing the title of the list, a compass rose button 2020, the list of items 2030, an “add item manually” text box 2040, a “scan search” button 2050, a “get info” button 2060, a “save and close” button 2070, and an advertising banner 2080. Individual items on the list 2030 are provided with an “add to meal planner” button 2032 and a status button (e.g., ‘yes’, ‘no’, or ‘?’) 2034.

The title is entered at list creation as described above. Users can click on this title bar 2010 and it will become a text field, where they can enter a new title. A save button may appear whenever the text field is active, and the title saves and reverts to the normal graphic 2010 when the save button is selected.

The items of the shopping list 2030 may be organized first by department and then listed in the order they were added to the list in. The departments may include produce, meat, dairy, canned foods, organic and specialty foods, breakfast foods, dry foods, desserts, frozen foods, and household items. For example, items on the list which are found in the dairy department of a store are clustered together and, within that group, sorted by when they were added. Such groupings may be designated by subheadings (not shown).

The “add item manually” option 2040 is shown above the list of items 2030. This option 2040 opens a pop-over screen 1100 similar to the one shown in FIG. 11 where the user can enter the information for an item.

Shown at the bottom of the active shopping lists screen 2000 of FIG. 20 is a “scan and search” button 2050. This allows the user to scan immediately from the active shopping list screen 2000. Activating this button 2050 takes the user to the scan and search screen 900 shown in FIG. 9.

The ‘get info’ button 2060 brings up a product report for a selected item.

The user can add items to a meal planner by selecting the associated “Add to meal planner” button 2032. The user may then be prompted with a screen 1600 asking which meal to add the item to such as shown in FIG. 16. In an alternative embodiment, the user is presented with a single “Add to meal planner” button (not shown). The user can then add items to a meal planner by highlighting the item or items and selecting this “Add to meal planner” button, or by dragging and dropping individual items onto the button.

In the embodiment shown, each item has a status indicator of ‘yes’ or ‘no’ 2034. Additional indicators may be ‘?’ or ‘null’. These status indicators 2034 provide easy reference tools for the user to track what they have purchased. In this example, a ‘yes’ indicates the item has been purchased and a ‘no’ indicates the item has been declined. Items may be shown with a ‘null’ indicator if no status has been updated (e.g., where the status is updated by selecting ‘Buy’ or ‘Decline’ from the product report screen 1200). A ‘?’ indicator signifies that the product was not obtained for some reason.

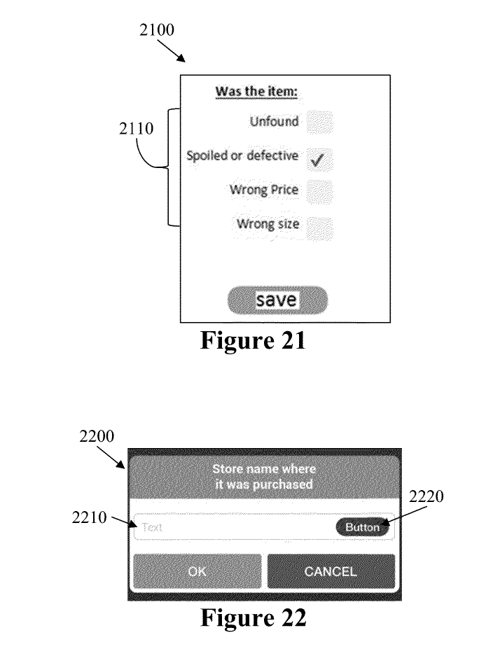

When setting a ‘?’ status, the user may be asked for clarification. FIG. 21 illustrates a pop-up screen 2100 requesting information when marking an item from a shopping list as not purchased for the software application. As shown, the user is provided a list 2110 of possible explanations as to why the product was not purchased. For example, if the user couldn't find the product; the product was spoiled/defective; the product was listed at the wrong price; or the store carried the product in the wrong size.

The status indicators 2034 may be used to color code the items. For example, items marked ‘No’ may have a red background, red text, strikethrough or other marking. Similarly, items marked ‘Yes’ may have a green background, green text, a checkmark icon, etc.

The shopping list 2030 may also be sorted based on the status indicators 2034. As one non-limiting example, items with ‘Yes’ or ‘No’ status indicators 2034 may be moved to the bottom of the list 2030 leaving ‘null’ and ‘?’ indicated items near the top of the list for easy reference while shopping.

The compass rose button 2020 at top right of the screen 2000 shown in FIG. 20 lets the user find out where an item has been purchased previously. This button 2020 may change appearance based on the currently selected item. If the item has not yet been purchased (or no item is selected) the button shows the compass rose 2020 as seen in FIG. 20. If the item has been purchased before, the compass rose symbol 2020 may be replaced with the store name (not shown). If there are multiple stores where the item was purchased, the name of where the item was purchased most recently or most often may be used.

In a further embodiment, the active shopping list screen 2000 may include an icon which displays a map indicating the current location (e.g., where the user has checked-in or based on a GPS reading). This image may replace the compass rose icon 2020 when no items are selected from the shopping list 2030.

Selecting the compass rose 2020 brings up a pop-over 2200 that allows the user to edit where they bought the item. FIG. 22 illustrates a pop-up screen 2200 requesting information when marking an item from a shopping list as purchased. This allows the user to input a store name into text box 2210 and/or indicate a map (by pressing the button 2220) to select the location. This information can then be referenced later in order to help the user purchase the item again.

In one embodiment, the app may automatically fill in this information based on where the user is located, e.g., based on a GPS reading. For example, using the phone's location the app may conclude the user is in a particular store and when the user marks an item as purchased at that location it automatically associates that store with the purchase. As another example, a user buys a list of items at a location the app recognizes as a Costco. Each item is marked as Costco automatically, so that the compass rose feature will display, “Costco” instead of the compass rose symbol in the future when purchasing that item.

In contrast, if the user's location is not known as a store, upon hitting the compass rose button 2020, the user may be asked “Where are you purchasing this item?” with a text field to input where they are purchasing it. This entry is saved as the product's location, and saved as a GPS location, so that any further purchases there can be logged as at that location. For example, a user buys pickled herring at a market which the app does not recognize. When the user selects the compass rose button 2020, it opens with the question, “Where are you purchasing this item?” and the user may edit a text field to provide the market's name.

If the user has excluded a retailer for promotions, when they are at that retailer, as established by GPS, they may be reminded that they have excluded themselves from that business's advertisements.

Using the app, users can “check-in” to various locations. The app may suggest a location based on the current location or the user may select the location using a search. For a limited time after a ‘check in,’ the app may assume the user is at the location, e.g., for the next hour.

Advertising can be targeted based on the geographic location of a user's IP address, GPS signal, or user ‘check-in’. Retailers and brands can also be advertised based on this location information, so that the ads can be targeted to a specific store location. As one example, a store may want to prevent other stores from advertising to shoppers in their super-markets. Alternatively, the store could choose to target users in a competing store.

The system can also use the location information to determine when the user is at the gym, the office, or at home. In those situations, online merchants may be prioritized.

The “save and close” button 2070 closes the shopping list so that it can no longer be edited and saves it as an old shopping list. Once all items are marked (e.g., ‘Yes’, ‘No’, or ‘?’) the user can save and close the list. FIG. 23 illustrates a pop-up screen 2030 providing a warning when closing a shopping list with unmarked items.

Active/current shopping lists become old shopping lists when they are “saved and closed.” An old shopping may also store data on each product on the shopping list including whether the product was purchased, declined, or unacquired; where the product was purchased (if purchased); and the product report details. Items may be prevented from being deleted from an old shopping list.

When displaying old shopping lists, the lists may be shown as a list of titles and the dates of when the list was closed. This list may be sorted by date of closure.

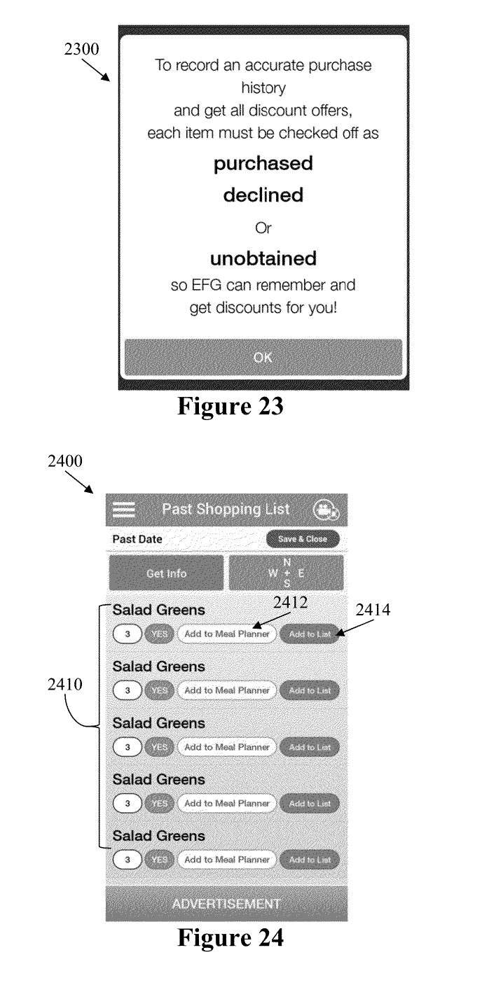

FIG. 24 illustrates a screen 2400 showing a closed shopping list 2400 for the software application. Selecting an old shopping list from the “all shopping lists” screen 1700 or a closed shopping list screen takes the user to the details for that old list, including a list 2410 of all items on that shopping list, their status as purchased, declined, or unacquired, and their product report. The user can add these items to new shopping lists, or add them to the meal planner. For example, by selecting an item from the list of items 2410 and selecting the “Add to Meal Planner” button 2412 or the “Add to List” button 2414, or dragging and dropping an item onto one of these buttons.

When adding items to a meal planner, the user may be asked for a profile or group. After selecting an established profiler or group (or making a new one), another pop-over can appear that lists the associated meals (which are set in the meal planner setup or profile). The user can add the item to any of the meals or snacks programmed (e.g., breakfast, lunch, dinner, snack 1, snack 2). The item will then show up in that meal's list.

When adding items to a shopping list, the user may be presented with a list of active shopping lists. The user may then select one of the lists or create a new one.

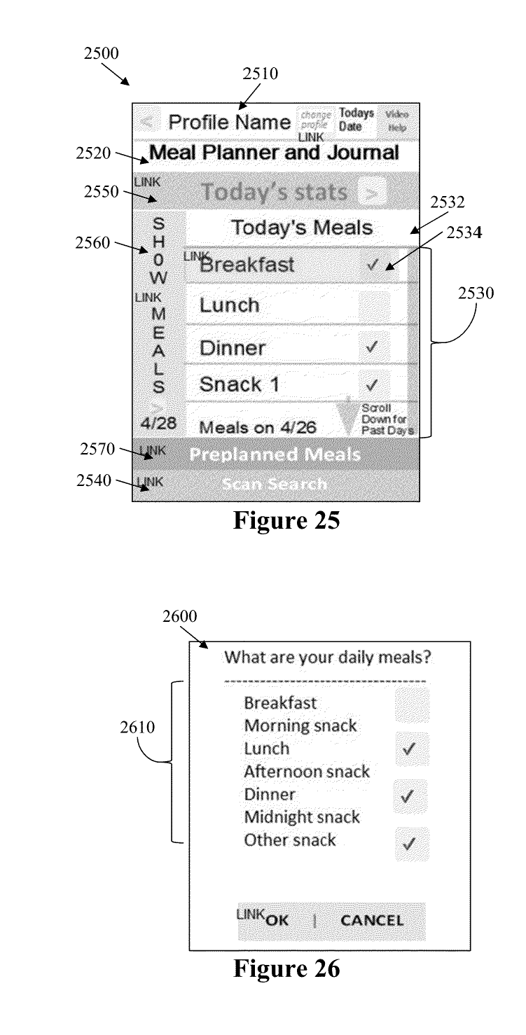

FIG. 25 illustrates a meal planner and journal screen 2500. When accessing this page 2500, the user may be asked to select a profile. The meal planner and journal screen 2500 is then shown with that profile's information. In this non-limiting embodiment, the meal planner and journal screen 2500 includes the name of the current profile 2510 (each profile can have its own meal planner and journal), a heading 2520, a list 2530 of the daily meals and snacks (as entered by the user in their profile preferences), a “Scan and search” button 2540, a “Today's stats” button 2550 and a “Show meals” button 2560.

Daily meals may be entered by the user when setting up their profile and/or edited later. Snacks may be added and are shown at the bottom of the meal list 2530. The user can scroll down to view entries from past days. By selecting a meal or a snack, the user may be shown a screen where they can add entries to that meal.

The “Scan and search” button 2540 allows the user to scan products and see product reports specific to the current profile. The “Show meals” button 2560 shows the user a list of upcoming meals. In this non-limiting embodiment the “Show meals” button 2560 includes the date of the next day, e.g., “4/28.” Selecting the date displays the meals for that day.

The log of prior meals may be maintained in accordance of various data retention restrictions. The log may be encrypted and secured from unauthorized access by third parties. The log may also be configured to automatically remove entries, for example, to delete data for days older than three months.

Each meal for the current day is shown under the “Today's Meals” label 2532. The user can select the box 2534 next to a listed meal to confirm the meal has been eaten.

Selecting the profile name 2510 allows the user to change profiles. They may be presented with a list of profiles and selecting one from the list will make that profile the current profile.

If no information is set up for the current profile, accessing the meal planner and journal screen 2500 may cause a meal planner set up screen 2600 to be shown. FIG. 26 illustrates a pop-up screen 2600 requesting information regarding meals selected for a profile for the software application. The user is provided with a list of meals 2610 to select as daily meals for the profile. For example, the user can select from: breakfast, morning snack, lunch, afternoon snack, dinner, midnight snack, or other snack. The selected meals are then added to the meal planner. Users can also change the selected meals for an existing profile by updating their preferences.

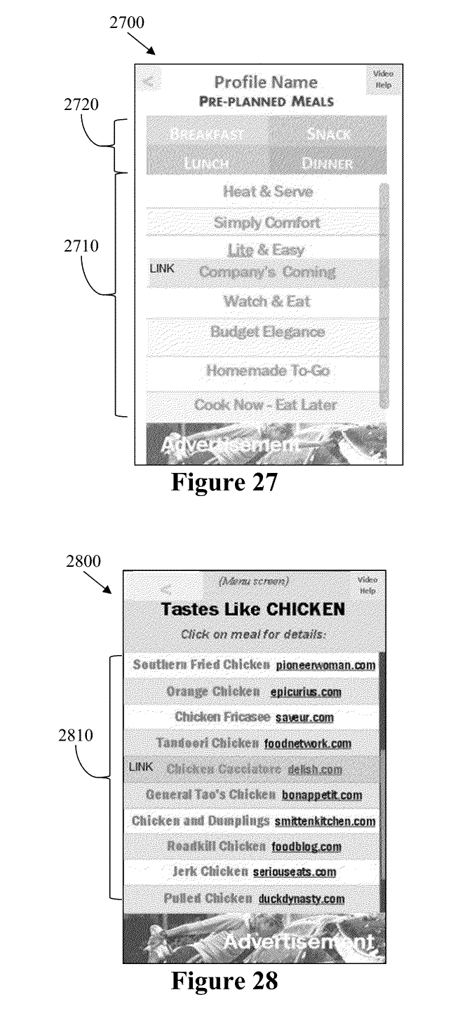

The “Pre-Planned Meals” button 2570 shown in FIG. 25 takes the user to the pre-planned meal screen 2700. FIG. 27 illustrates a screen 2700 showing pre-planned meal categories 2710 for the software application. This screen 2700 allows the users to review meals which have been planned in advance. The “breakfast,” “lunch,” “dinner” and “snack” buttons 2720 allow the user to quickly select a broad category of pre-planned meals. As shown, additional sub-categories are listed, such as “Heat & Serve,” “Budget Elegance,” etc. The user can scroll through the list 2710 and select a sub-category.

FIG. 28 illustrates a screen 2800 showing sample meals in a pre-planned meal sub-category. As shown, meals in the “Tastes Like Chicken” category are displayed. Users can browse different pre-planned menus of the meal type they have selected. The listing of meals 2810 may be sorted by when the meals were created, e.g., most recent first. Alternatively, the list 2810 may be sorted based on the active profile preferences, so that users see meals that fit the active profiles first (e.g., by moving meals which omit or have less of a food the user is limiting closer to the top).

In one non-limiting embodiment, the meals that are displayed for an individual or a group conform to the preferences of the individual or to the preferences of all profiles in the group. Meals which do not conform to the preferences are not shown. For example: if there's an active profile that excludes gluten in a group, anyone planning meals for the group will not be shown pre-planned meals that contain gluten. Likewise, if the group includes vegans then meals containing animal products would not be presented. Meals/recipes may also be provided with alternative features, for example, a meal may have a standard gravy option and a second, gluten-free gravy option. The alternative features may be automatically provided based on the preferences of all profiles in the group. As one, non-limiting example, each meal offered for a group which includes a profile that excludes gluten is provided with the gluten-free alternative automatically.

Each meal includes a title, a brief description, one or more categories, a list of ingredients (e.g., a shopping list) and instructions for preparation. These meals may be stored in the system as a large catalog of meals. New meals can be added and existing meals may be updated.

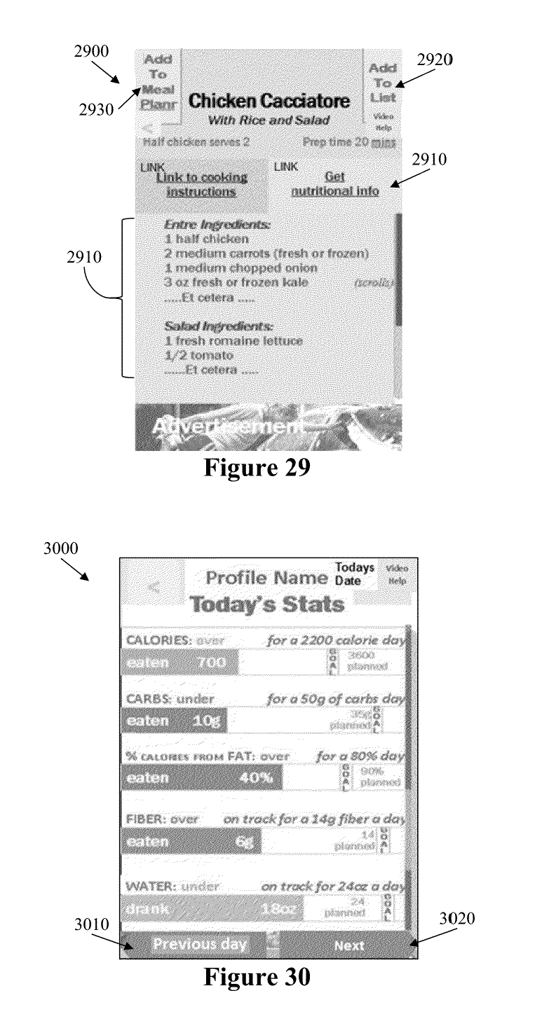

Selecting a meal displays a screen 2900 with information regarding that meal. FIG. 29 illustrates a screen 2900 showing a sample meal for the software application. The listing information can include a photo of the meal (when available), the name of the meal, the name and description of all the dishes, an estimated prep time, a link to further details (e.g., a website or video), and a list of ingredients.

The user can also select the “Get nutritional info” button 2910 in order to get a product report for any selected ingredient in the meal. Alternatively, the user can receive nutritional information of the meal as a whole when no ingredient is selected.

Using the “add to list” button 2920 and “add to meal” button 2930, the user can add the meal or individual ingredients to a shopping list or meal planner. The user can drag and drop the name of the whole meal to a button 2920, 2930 to add all the ingredients accordingly. A pop-over may be presented to ask the user to select a meal and day to assign the pre-planned meal to when adding to a meal planner. Proportions listed in the pre-planned meal details may be used for the meal planner. Similarly, the user may be prompted to select a shopping list which is to have the ingredients added.

As an example, a user drags and drops the entire “Chicken Cacciatore” meal to “add to list.” The “which list?” pop-over comes up. The user selects “Add to new list” and titles the list “Lunch.” The meal calls for ½ a chicken—this exact value appears in the shopping list. Additionally, the number of people scheduled for a meal may change the proportions of ingredients added to the shopping list. For example, the “Chicken Cacciatore” meal is shown as serving two people, if 4 people are scheduled for the meal, the shopping list may double the ingredients (e.g., 1 whole chicken added to the list rather than 1 half chicken). The quantity adjustment may be performed automatically or a prompt may be shown to confirm the change.

The user may also add the meal to their meal planner. A pop-over appears that shows them the date and meal of the day they can add this meal to, which they select. Adding the entire meal adds the ingredients proportionally (e.g., if the meal is listed as serving 2 people, the system adds ½ of the meal to the meal planner for each person at the meal).

FIG. 30 illustrates a screen 3000 showing a status report for a selected profile for the software application. Users can access this screen by selecting the “Today's stats” button 2550 on FIG. 25. The today's stats screen 3000 shows calorie, macronutrient, and micronutrient information for the day. These are determined based on foods added to meals, and are compared to the current profile's daily goals.

As shown in this non-limiting embodiment, the goals are displayed in bar graph format. For example, the user has consumed 10 g of carbs, which is 20% of their carbs (50 g) for the day. Their planned meals would bring them to 35 g. The bar will show in one color the carbs already consumed as a percentage of the total planned, and show that the planned total is less than the total allowed.

At the bottom of the screen 3000 are two buttons: “Previous day” 3010 and “Next” 3020. Using these buttons 3010, 3020, the user can review the ‘Today's Stats” for the associated day.

Additionally, the application can track a user's progress on their goals throughout the day, for example, as they enter the meals eaten or at various points in the day. The application may then provide an alert or other message to the user. For example, if the profile shows the user is limiting carb intake but the user enters meal data at 11 am which shows they are at 80% of their goal the application may show a warning message to reduce their intake. Likewise, if the user has a goal of 24 oz. of water per day but has only had 8 oz. by 1 pm the application may issue a message advising the user to drink more water in order to meet their goal.

The application may check the progress towards goals periodically, at set times and/or based on user action. The alerts may then be provided either when the user access the application and/or as a notification on device. Notifications outside the application may be provided to devices may be sent to devices specifically linked to the profile in the profile preferences and/or to all devices linked to the account. Such messages may be generated on the device and/or may be generated by the system and sent in an email, text or other communication.

The alerts/messages may also be provided as the user meets their goals or is on track to meet them. This may unlock various features, such as stickers and/or other in application items. Such messages may also prompt the user to post their progress to a social network. For example, upon successfully meeting their goals for 2 weeks, the user may receive a congratulations message with an option to share the message with their friends.

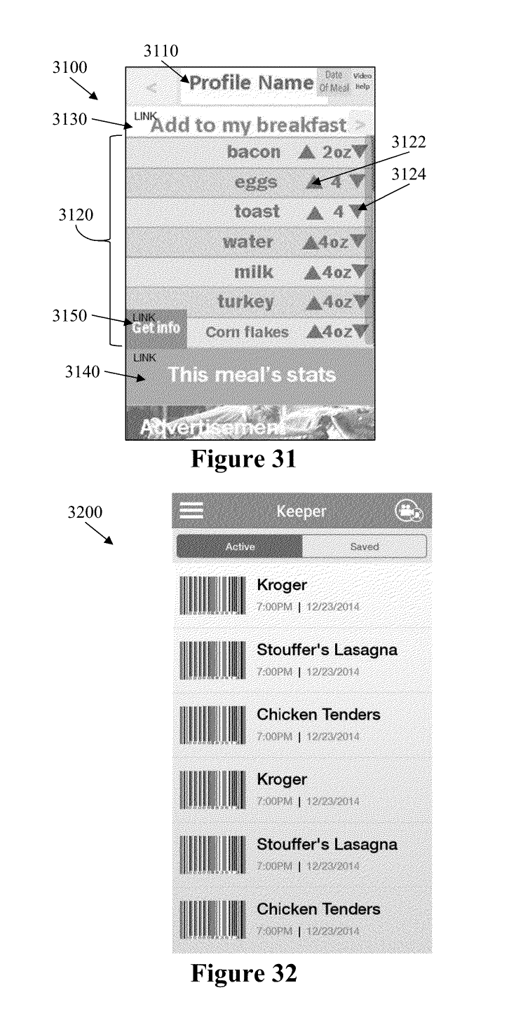

FIG. 31 illustrates a meal data screen 3100. Selecting a meal or snack for a day takes the user to the meal screen 3100 for that meal or snack. This screen 3100 includes a title bar 3100 with the active/current profile and the date of the meal. The screen 3100 also includes a list 3120 of food entries for the meal. The “Add to my breakfast” button 3130 allows the user to find foods that are then added to the meal planner for the current meal. The user can also see the stats for the meal using the “This meal's stats” button 3140.

Similarly to as seen in screen 2500, the user can change the current profile by selecting the profile name in the title bar 3100. The user can access product report screens for the list foods using the “Get info” button 3150.

The “Add to my meal” button 3130, from which a user can access foods to add to the meal, brings up the “this meal's foods” list. This list consists of commonly eaten foods at that meal, foods specific to the profile's established diet (if one is chosen) and/or foods they have added to this meal's list. As one example, a user adds lasagna to their meal planner for a lunch. Now, when they select the “add to my meal” button 3130 in the lunch meal, the list that comes up includes the lasagna.

The list of foods in the add foods list may be sorted from top to bottom by frequency of consumption. The list may also be tailored to the profile's preferences either to exclude foods to be avoided and/or to show foods suitable to their listed goals closer to the top of the list.

The food entries in the list 3120 for that meal are assigned portions. The user can adjust the portions assigned. In this non-limiting example, the portion size selected is shown with an up arrow 3122 and a down arrow 3124. Using these arrows 3122, 3124, the user can increase or decrease the portion (or number of servings).

The UI may change the display depending on this food's impact on their nutritional goals, for example, by darkening the background of foods which have a larger effect on the listed goals. Foods which help meet the goals may be shaded green while foods that are being limited may be shown in red (with foods taking up more of the allowed maximum being darker).

The user may delete entries by holding them down, which can bring up a pop-over asking the user to confirm the deletion.

The “this meal's stats” button 3140 has a similar display as the “today's stats” screen 3000 shown in FIG. 30. The nutritional inputs from the meal (as currently entered) is shown in a different color on the bar graphs, so that the user can gauge how what they are planning to eat during a specific meal will impact their daily goals.

FIG. 32 illustrates a coupon keeper screen 3200. Selecting the “Coupon Keeper” button 450 on the home screen 400 shown in FIG. 4 brings the user to this screen 3200. The coupon keeper keeps and tracks all the coupons that the user has saved. Coupons may be deleted automatically when they expire. The coupon keeper sorts coupons into “active” and “saved” coupons. Each coupon can include the expiration date, the name of the product (or products) the discount is for and the barcode or coupon code. The app can also store additional coupon information, for example, a photo of the coupon.

Active coupons are coupons for which an item in an active shopping list has been marked, “yes.” For example, a user at the grocery store marks “mac and cheese” as “yes.” The coupon for this item automatically enters the “active” list. If there are multiple coupons available, the greater value of discount can be moved to the active list of the coupon keeper. Alternatively, the soonest to expire may be moved to the active list.

When the user is checked-in to a store, that store's loyalty card can also display at the top of the active coupons. Coupons can be scrolled so that the cashier can scan them individually.

The coupon keeper can generate reminders about the expiration of time sensitive offers. Reminders may automatically go off at 30, 10, and 5 minutes to expiration. These notifications can appear on the phone showing the remaining time available.

Saved coupons are coupons for which there is not a product marked as, “yes,” in an active shopping list. For example, a user finds a coupon in the newspaper for mac and cheese. They scan it with their phone and record it in the saved coupons. It does not appear in the active coupons until the user selects mac and cheese for purchase.

If a coupon is available for a scanned product or a search result, the product report screen 1200 can notify the user accordingly. As one non-limiting example, the “product report” header 1290 can change color based on the presence or absence of coupons for that item. If there is a coupon, the header 1290 can say in bold letters “COUPON!” with a green background. If there is no coupon, the header 1290 keeps the normal appearance.

If a user scans a discount/coupon barcode from the newspaper or other location, the system can perform a check of the coupon. If the coupon is expired, the app can report this to the user, e.g., with a pop-over stating “This coupon has expired.” If the coupon is current (not-expired), a pop-over confirms the coupon is valid and may let the user know when it expires, e.g., by stating “This coupon is now in your coupon keeper. X days until expiration.”

A notification may be shown after a shopping list is saved and closed in order to inform the user how much they saved with the coupon keeper. This amount is determined as the sum of coupon savings on items which they marked as purchased in that shopping visit. For example, they may be shown a message such as “eFoodGuru saved you $xxx.xx on 5/5/14 on list (Kroger's).”

Advertising banners appear on various screens, for example, advertisements 1270 in FIG. 12, advertising banner 1740 in FIG. 17, and advertising banner 2080 in FIG. 20. The user can click the ad which causes a pop-over to appear with the entire promotion. Some ads may have another option, e.g., to touch a button to receive a coupon or to get a coupon code for an online merchant. Many codes and coupons may be time sensitive. The user can be told how urgent it is for them to use the code, e.g., a countdown clock when the promotion expires in a matter of minutes. If the user doesn't save the coupon or code, the opportunity may be lost, unless the user happens to encounter the ad again.

The advertisements that the users are shown may be customized so that they are appropriate to all the active profiles. For example, if one profile in the account does not eat gluten, ads with products containing gluten are not shown to anyone using the account. Additionally ads featuring gluten-free products may be prioritized or used instead. Likewise, vegans are not shown products containing meat, fish or eggs. This changes the ads from being an annoyance to a service.

The effectiveness of the ads is increased because the ads that are shown are those that are most relevant to the user. Rather than providing generic ads to all user (which makes those few ads that are actually displayed to an interested party relatively expensive), advertising may be done in a targeted manner so that ads are targeted to more receptive parties (making each individual ad more valuable). For example, while many people may not be specifically interested in gluten-free products, an account with someone that does not eat gluten may be more receptive to ads for gluten-free products.

In one non-limiting embodiment, whenever the user goes from one screen to another, for instance, from an active shopping list screen 2000 to the all shopping lists screen 1700, they will be shown a different ad, and each time a user refreshes a screen a new ad appears. Users may also swipe through ads to look for coupons or discounts they prefer. They can get as many ads as they want in this way. Alternatively, ads may refresh automatically and/or be displayed for a set time such that the same ad may carry over to subsequent screens.

Point of sale advertising can be distinguished in the app from regional or national advertising. Point of sale advertising for users may be displayed in a way that is specific to the user's location, e.g., so that no competing chains are advertised to customers when the customer is in a particular store. Regional and national advertising is targeted by region rather than by exact store or chain location of the user. Priority may be given to point of sale advertising such that those ads appear more often.

Additionally, users may be able to access a page of recommended ads. These ads, like those discussed above, are based on their preferences. For example, users who have indicated they are restricting sodium may be presented with ads which feature low-sodium foods.

Some ads may have coupons and others ads may not. The server can track when ads with or without coupons result in purchases (marked ‘yes’ in the shopping list) and/or the product being added to a shopping list. The user may then be provided details regarding the how much they have saved using such the coupons. Manufacturers and retailers can receive data regarding how often users look at ads and/or when those ads result in purchases.

The system also allows users to publishing their shopping lists, meal planner entries, detailed profiles, fitness routines, and product reports. Other users viewing these items can then download them to their own account so they can buy the same items, follow the same diet, or do the same fitness routines on their own.

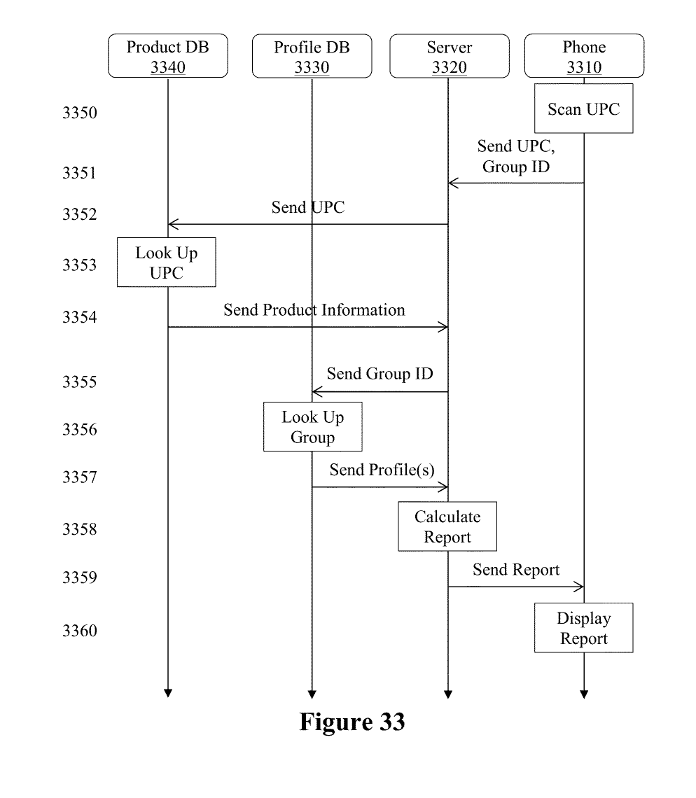

FIG. 33 shows a signaling diagram of a scan and search operation in accordance with an embodiment. In this non-limiting embodiment, at time 3350 a user uses their phone 3310 to scan a UPC. The scanned UPC and a group ID are sent to the server 3320 at time 3351. Then, at time 3352, the server 3320 relays the scanned UPC to a product DB 3340, which looks up the UPC at time 3353 to get the product information and sends the product information to the server 3320 at time 3354. The server 3320 also sends, at time 3355, the group ID to a profile DB 3330 which determines the associated profiles with that group at time 3356 and provides the relevant profile data to the server 3320 at time 3357.

At time 3358, once the server 3320 has accessed the profile information and product information, the server 3320 calculates a product report. This information is then sent at time 3356 to the phone 3310 which displays it for the user at time 3360.

In alternative embodiments, the phone 3310 provides one or more profile IDs to the server 3320 which uses the profile IDs to look up the associated profiles in the profile DB 3330.

In a further alternative embodiment, the profile DB 3330 may send only the relevant profile preferences to the server 3320, for example, the profile DB 3330 may compile a list of only the product details indicated as being watched by the profiles. As one non-limiting example, there are two profiles in the group. The first profile is watching sodium and fat and the second profile is watching fat and sugar. Then the compiled list would indicate sodium, fat and sugar.

In another alternative embodiment, the server 3320 may send the UPC to the product DB 3340 and the group ID to the profile DB 3330 in any appropriate timing order or simultaneously, for example, the server 3320 may send the group ID and then before receiving the associated profiles, the server 3320 may also send the UPC.

As a non-limiting example, the server 3320 provides calculation of the reports, lists and planners. This allows additional features to be added and existing services to be updated at the server 3320, so that the data on the user's phone 3310 is not impacted by the upgrade and the user is able to enjoy a consistent experience.

The relative times for various actions described in FIG. 33 are purely exemplary and imply no particular order. Further, the operations can be used in any sequence when appropriate and can be partially used. Additional embodiments can employ additional actions; combine multiple actions; and/or perform actions simultaneously. For example, the server 3320 may send the group ID while awaiting the product information or may send the group ID prior to sending the UPC.

As a further example, the messages and communications between the various elements 3310, 3320, 3330, 3340 may be encrypted or otherwise protected from third party interception. Likewise, data stored in the DBs 3330, 3340 may also be protected from unauthorized access. Accordingly, additional actions may be taken to encrypt/decrypt communications and database lookups.

As described above, various exemplary embodiments provide methods, apparatus and computer programs to provide shopping assistance including the use of a food label reader app.

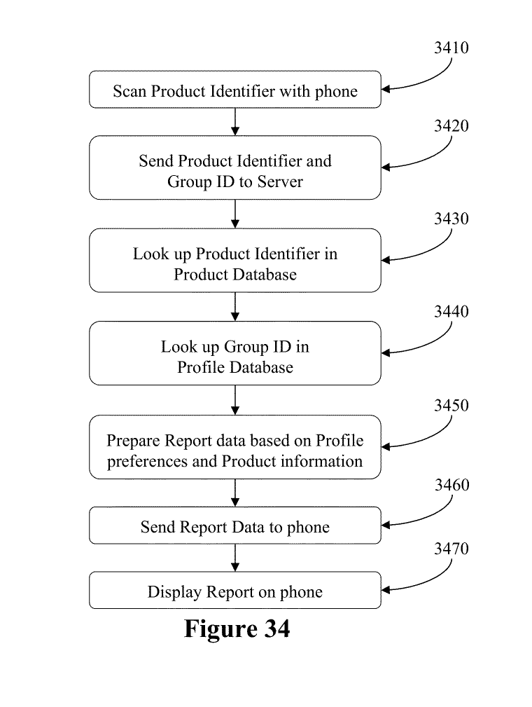

FIG. 34 is a logic flow diagram that illustrates a method, and a result of execution of computer program instructions, in accordance with exemplary embodiments. In accordance with an embodiment a method performs a step of scanning a product identifier with a phone, for example, by scanning a UPC or reading an RFID. The phone sends the product identifier and a group ID to the server. The server looks up the product identifier in product database, for example, DB2 of FIG. 2, and the server looks up the group ID in a profile database, for example, DB 1 of FIG. 1. Based on the profile preferences received from the profile database and the product information from the product data base, the server prepares report data. The server sends the report data to the phone and the phone displays the report.

The various blocks shown in FIG. 34 may be viewed as method steps, as operations that result from use of computer program code, and/or as one or more logic circuit elements constructed to carry out the associated functions.

An embodiment provides a method for reviewing a product and providing a recommendation. The method includes receiving, at a server, a ProductID and a GroupID from a first device. Product information is determined based at least in part on the ProductID. At least one profile preference is determined based at least in part on the GroupID. The method also includes generating a product report for the product identified by the ProductID based at least in part on the product information and the at least one profile preference. The product report includes at least one graphic indication of whether the product meets the at least one profile preference. The product report is sent to the first device from the server.

In a further embodiment of the method above, the method also includes determining the ProductID by scanning a label on a product.

In another embodiment of any one of the methods above, the method also includes displaying the product report on a display at the first device.

In a further embodiment of any one of the methods above, determining the at least one profile preference includes looking up the GroupID in a profile database and receiving profile preference data for each active profile associated with the GroupID.

In another embodiment of any one of the methods above, a profile preference for a profile includes at least one of: an indication of nutrients the profile is limiting (e.g., the profile is restricting intake up to a maximum amount of a nutrient); an indication of nutrients the profile prefers (e.g., the profile is attempting to get at least a minimum amount of the nutrient); and an indication of foods the profile is avoiding (e.g., the profile does not want at all, such as due to a religious exclusion and/or an allergy).

In a further embodiment of any one of the methods above, the product information includes at least one of: a list of ingredients for the product and nutritional data for the product.

In another embodiment of any one of the methods above, generating the product report includes, for each food being avoided indicated in the at least one profile preference, determining whether the product includes the avoided food; and in response to determining that the product includes at least one avoided food indicated in the at least one profile preference, adding a graphic indication to the product report indicating that the product does not met the at least one profile preference. The graphic indication that the product does not met the at least one profile preference may include an indication of the at least one avoided food present in the product.

In a further embodiment of any one of the methods above, generating the product report includes, for each nutrient indicated as being avoided in the at least one profile preference, determining whether the product is high in the avoided nutrient; and, in response to determining that the product is high in at least one avoided nutrient, adding a graphic indication to the product report indicating that the product does not met the at least one profile preference.

In another embodiment of any one of the methods above, generating the product report includes, for each nutrient indicated as being preferred in the at least one profile preference, determining whether the product is low in the preferred nutrient; and in response to determining that the product is low in at least one preferred nutrient, adding a graphic indication to the product report indicating that the product does not met the at least one profile preference.

In a further embodiment of any one of the methods above, the method also includes determining whether at least one coupon for the product is associated with the GroupID; and, in response to determining that at least one coupon for the product is associated with the GroupID, adding a graphic indication to the product report indicating that a coupon is available for the product.

In another embodiment of any one of the methods above, the method also includes adding a graphic advertisement to the product report based at least in part on the at least one profile preference. Adding the graphic advertisement may also be based on a geographic location of the first device.

In a further embodiment of any one of the methods above, the method also includes receiving an indication that the product is being purchased; and adding an indicator that the product has been purchased to at least one shopping list associated with the GroupID. The indicator that the product has been purchased may include an identifier of a store where the product has been purchased.

In another embodiment of any one of the methods above, generating the product report includes adding a list of at least one ingredient of the product. The list is sorted based at least in part on the at least one profile preference.

In a further embodiment of any one of the methods above, generating the product report includes adding a list of at least one nutritional data of the product. The list is sorted based at least in part on the at least one profile preference.

Another embodiment provides an apparatus (such as a server, for example) for reviewing a product and providing a recommendation. The apparatus includes one or more processors and one or more memories. The memories storing computer program code. The memories and the computer program code are configured to, with the processors, cause the apparatus to perform actions. The actions include receiving, at the apparatus, a ProductID and a GroupID from a first device. Product information is determined based at least in part on the ProductID. At least one profile preference is determined based at least in part on the GroupID. The actions also include generating a product report for the product identified by the ProductID based at least in part on the product information and the at least one profile preference. The product report includes at least one graphic indication of whether the product meets the at least one profile preference. The product report is sent to the first device from the server.

In a further embodiment of the apparatus above, the actions also include determining the ProductID by scanning a label on a product.

In another embodiment of any one of the apparatus above, the actions also include displaying the product report on a display at the first device.

In a further embodiment of any one of the apparatus above, determining the at least one profile preference includes looking up the GroupID in a profile database and receiving profile preference data for each active profile associated with the GroupID.

In another embodiment of any one of the apparatus above, a profile preference for a profile includes at least one of: an indication of nutrients the profile is limiting; an indication of nutrients the profile prefers; and an indication of foods the profile is avoiding.

In a further embodiment of any one of the apparatus above, the product information includes at least one of: a list of ingredients for the product and nutritional data for the product.

In another embodiment of any one of the apparatus above, generating the product report includes, for each food being avoided indicated in the at least one profile preference, determining whether the product includes the avoided food; and in response to determining that the product includes at least one avoided food indicated in the at least one profile preference, adding a graphic indication to the product report indicating that the product does not met the at least one profile preference. The graphic indication that the product does not met the at least one profile preference may include an indication of the at least one avoided food present in the product.

In a further embodiment of any one of the apparatus above, generating the product report includes, for each nutrient indicated as being avoided in the at least one profile preference, determining whether the product is high in the avoided nutrient; and, in response to determining that the product is high in at least one avoided nutrient, adding a graphic indication to the product report indicating that the product does not met the at least one profile preference.

In another embodiment of any one of the apparatus above, generating the product report includes, for each nutrient indicated as being preferred in the at least one profile preference, determining whether the product is low in the preferred nutrient; and in response to determining that the product is low in at least one preferred nutrient, adding a graphic indication to the product report indicating that the product does not met the at least one profile preference.

In a further embodiment of any one of the apparatus above, the actions also include determining whether at least one coupon for the product is associated with the GroupID; and, in response to determining that at least one coupon for the product is associated with the GroupID, adding a graphic indication to the product report indicating that a coupon is available for the product.

In another embodiment of any one of the apparatus above, the actions also include adding a graphic advertisement to the product report based at least in part on the at least one profile preference. Adding the graphic advertisement may also be based on a geographic location of the first device.

In a further embodiment of any one of the apparatus above, the actions also include receiving an indication that the product is being purchased; and adding an indicator that the product has been purchased to at least one shopping list associated with the GroupID. The indicator that the product has been purchased may include an identifier of a store where the product has been purchased.

In another embodiment of any one of the apparatus above, generating the product report includes adding a list of at least one ingredient of the product. The list is sorted based at least in part on the at least one profile preference.

In a further embodiment of any one of the apparatus above, generating the product report includes adding a list of at least one nutritional data of the product. The list is sorted based at least in part on the at least one profile preference.

In another embodiment of any one of the apparatus above, the apparatus is embodied in a server.

A further embodiment provides a computer readable medium for reviewing a product and providing a recommendation. The computer readable medium is tangibly encoded with a computer program executable by a processor to perform actions. The actions include receiving, at a server, a ProductID and a GroupID from a first device. Product information is determined based at least in part on the ProductID. At least one profile preference is determined based at least in part on the GroupID. The actions also include generating a product report for the product identified by the ProductID based at least in part on the product information and the at least one profile preference. The product report includes at least one graphic indication of whether the product meets the at least one profile preference. The product report is sent to the first device from the server.

In another embodiment of the computer readable medium above, the actions also include determining the ProductID by scanning a label on a product.

In a further embodiment of any one of the computer readable media above, the actions also include displaying the product report on a display at the first device.

In another embodiment of any one of the computer readable media above, determining the at least one profile preference includes looking up the GroupID in a profile database and receiving profile preference data for each active profile associated with the GroupID.

In a further embodiment of any one of the computer readable media above, a profile preference for a profile includes at least one of: an indication of nutrients the profile is limiting; an indication of nutrients the profile prefers; and an indication of foods the profile is avoiding.

In another embodiment of any one of the computer readable media above, the product information includes at least one of: a list of ingredients for the product and nutritional data for the product.

In a further embodiment of any one of the computer readable media above, generating the product report includes, for each food being avoided indicated in the at least one profile preference, determining whether the product includes the avoided food; and in response to determining that the product includes at least one avoided food indicated in the at least one profile preference, adding a graphic indication to the product report indicating that the product does not met the at least one profile preference. The graphic indication that the product does not met the at least one profile preference may include an indication of the at least one avoided food present in the product.

In another embodiment of any one of the computer readable media above, generating the product report includes, for each nutrient indicated as being avoided in the at least one profile preference, determining whether the product is high in the avoided nutrient; and, in response to determining that the product is high in at least one avoided nutrient, adding a graphic indication to the product report indicating that the product does not met the at least one profile preference.

In a further embodiment of any one of the computer readable media above, generating the product report includes, for each nutrient indicated as being preferred in the at least one profile preference, determining whether the product is low in the preferred nutrient; and in response to determining that the product is low in at least one preferred nutrient, adding a graphic indication to the product report indicating that the product does not met the at least one profile preference.

In another embodiment of any one of the computer readable media above, the actions also include determining whether at least one coupon for the product is associated with the GroupID; and, in response to determining that at least one coupon for the product is associated with the GroupID, adding a graphic indication to the product report indicating that a coupon is available for the product.

In a further embodiment of any one of the computer readable media above, the actions also include adding a graphic advertisement to the product report based at least in part on the at least one profile preference. Adding the graphic advertisement may also be based on a geographic location of the first device.

In another embodiment of any one of the computer readable media above, the actions also include receiving an indication that the product is being purchased; and adding an indicator that the product has been purchased to at least one shopping list associated with the GroupID. The indicator that the product has been purchased may include an identifier of a store where the product has been purchased.

In a further embodiment of any one of the computer readable media above, generating the product report includes adding a list of at least one ingredient of the product. The list is sorted based at least in part on the at least one profile preference.

In another embodiment of any one of the computer readable media above, generating the product report includes adding a list of at least one nutritional data of the product. The list is sorted based at least in part on the at least one profile preference.

In a further embodiment of any one of the computer readable media above, the computer readable medium is a storage medium.

In another embodiment of any one of the computer readable media above, the computer readable medium is a non-transitory computer readable medium (e.g., CD-ROM, RAM, flash memory, etc.).

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method, comprising:
receiving, at a server, a product identifier and a group identifier from a first device;
determining product information based at least in part on the product identifier;
determining at least one profile preference based at least in part on the group identifier;
generating a product report for the product identified by the product identifier based at least in part on the product information and the at least one profile preference, wherein the product report includes at least one graphic indication of whether the product meets the at least one profile preference; and
sending the product report to the first device from the server.

2. The method of claim 1, further comprising determining the product identifier by scanning a label on a product.

3. The method of claim 1, further comprising displaying the product report on a display at the first device.

4. The method of claim 1, wherein determining the at least one profile preference comprises looking up the group identifier in a profile database and receiving profile preference data for each active profile associated with the group identifier.

5. The method of claim 1, wherein a profile preference for a profile comprises at least one of: an indication of nutrients the profile is limiting; an indication of nutrients the profile prefers; and an indication of foods the profile is avoiding.

6. The method of claim 1, wherein the product information includes at least one of: a list of ingredients for the product and nutritional data for the product.

7. The method of claim 1, wherein generating the product report comprises:
for each food being avoided indicated in the at least one profile preference, determining whether the product includes the avoided food; and
in response to determining that the product includes at least one avoided food indicated in the at least one profile preference, adding a graphic indication to the product report indicating that the product does not met the at least one profile preference.

8. The method of claim 7, wherein the graphic indication that the product does not met the at least one profile preference includes an indication of the at least one avoided food present in the product.

9. The method of claim 1, wherein generating the product report comprises:
for each nutrient indicated as being avoided in the at least one profile preference, determining whether the product is high in the avoided nutrient; and
in response to determining that the product is high in at least one avoided nutrient, adding a graphic indication to the product report indicating that the product does not met the at least one profile preference.

10. The method of claim 1, wherein generating the product report comprises:
for each nutrient indicated as being preferred in the at least one profile preference, determining whether the product is low in the preferred nutrient; and
in response to determining that the product is low in at least one preferred nutrient, adding a graphic indication to the product report indicating that the product does not met the at least one profile preference.

11. The method of claim 1, further comprising:
determining whether at least one coupon for the product is associated with the group identifier; and
in response to determining that at least one coupon for the product is associated with the group identifier, adding a graphic indication to the product report indicating that a coupon is available for the product.

12. The method of claim 1, further comprising adding a graphic advertisement to the product report based at least in part on the at least one profile preference.

13. The method of claim 12, wherein adding the graphic advertisement is further based on a geographic location of the first device.

14. The method of claim 1, further comprising:
receiving an indication that the product is being purchased; and
adding an indicator that the product has been purchased to at least one shopping list associated with the group identifier.

15. The method of claim 14, wherein the indicator that the product has been purchased includes an identifier of a store where the product has been purchased.

16. The method of claim 1, wherein generating the product report comprises adding a list of at least one ingredient of the product, wherein the list is sorted based at least in part on the at least one profile preference.

17. The method of claim 1, wherein generating the product report comprises adding a list of at least one nutritional data of the product, wherein the list is sorted based at least in part on the at least one profile preference.

18. An apparatus, comprising at least one processor; and at least one memory including computer program code, the at least one memory and the computer program code configured to, with the at least one processor, cause the apparatus to perform at least the following:
to receive a product identifier and a group identifier from a first device;
to determine product information based at least in part on the product identifier;
to determine at least one profile preference based at least in part on the group identifier;
to generate a product report for the product identified by the product identifier based at least in part on the product information and the at least one profile preference, wherein the product report includes at least one graphic indication of whether the product meets the at least one profile preference; and
to send the product report to the first device.

19. The apparatus of claim 18, wherein, when generating the product report, the at least one memory and the computer program code are further configured to cause the apparatus:
for each food indicated as being avoided in the at least one profile preference, determining whether the product includes the avoided food; and
for each nutrient indicated as being limited in the at least one profile preference, determining whether the product is high in the limited nutrient; and
for each nutrient indicated as being preferred in the at least one profile preference, determining whether the product is low in the preferred nutrient; and
in response to determining at least one of: that the product includes at least one avoided food; that the product is high in at least one avoided nutrient; and that the product is low in at least one preferred nutrient, adding a graphic indication to the product report indicating that the product does not met the at least one profile preference.

20. The apparatus of claim 18, wherein the at least one memory and the computer program code are further configured to cause the apparatus:
to receive an indication that the product is being purchased; and
to add an indicator that the product has been purchased to at least one shopping list associated with the group identifier.
